(19) United States
(12) Patent Application Publication
(10) Pub. No.: US 2014/0120431 A1
(43) Pub. Date: May 1, 2014

(54) COMPOSITE POLYMER ELECTROLYTE MEMBRANE

(71) Applicants: Mark Gerrit Roelofs, Earleville, MD (US); Biswajit Choudhury, Wilmington, DE (US); Junaid Ahmed Siddiqui, Richmond, VA (US); Shoibal Banerjee, Landenberg, PA (US)

(72) Inventors: Mark Gerrit Roelofs, Earleville, MD (US); Biswajit Choudhury, Wilmington, DE (US); Junaid Ahmed Siddiqui, Richmond, VA (US); Shoibal Banerjee, Landenberg, PA (US)

(73) Assignee: E I DU PONT DE NEMOURS AND COMPANY, Wilmington, DE (US)

(21) Appl. No.: 14/123,839

(22) PCT Filed: Jun. 15, 2012
(86) PCT No.: PCT/US12/42797

§ 371 Date: Dec. 4, 2013

Related U.S. Application Data
(60) Provisional application No. 61/498,461, filed on Jun. 17, 2011.

(51) Int. Cl. H01M 8/10

(52) U.S. Cl. CPC H01M 8/102; H01M 8/103; H01M 8/1032; H01M 8/1039
USPC 429/408; 429/492; 429/482

(57) ABSTRACT

Disclosed are composite polymeric ion exchange membranes and processes for their production and use in electrochemical cells, wherein ion exchange polymers are impregnated into non-consolidated nanowebs.

### FIELD OF THE INVENTION

Disclosed are composite polymeric ion exchange membranes and processes for making composite polymeric ion exchange membranes for use in a wide variety of electrochemical cells.

### BACKGROUND

A variety of electrochemical cells fall within a category of cells often referred to as solid polymer electrolyte (SPE) cells. A SPE cell typically employs a membrane of a cation exchange polymer, also known as the “ionomeric polymer membrane” or “polymer electrolyte membrane”, that serves as a physical separator between an anode and a cathode, while also serving as an electrolyte. SPE cells can be operated as electrolytic cells for the production of electrochemical products or they may be operated as fuel cells. SPE fuel cells typically also comprise a porous, electrically conductive sheet material that is in electrical contact with each of the electrodes, and permits diffusion of the reactants to the electrodes. In fuel cells that employ gaseous reactants, this porous, conductive sheet material is sometimes referred to as a gas diffusion layer and can be made of a carbon fiber paper or carbon cloth. An assembly which includes the membrane, the anode and the cathode, and the gas diffusion layers for each electrode, is sometimes referred to as a membrane electrode assembly (MEA).

It is desirable to use increasingly thinner membranes, particularly for transportation applications, to raise the electrical efficiency and/or conductivity of the MEA at higher power densities and to simplify the water management. Thinner membranes have reduced strength and tear resistance and may also be subject to significant dimensional change as the water content of the membrane varies. Composite membrane structures, wherein the membrane contains a reinforcing material, have been proposed as a means to overcome these problems. However, the composite membranes must be thinner in order to still have adequate conductivity.

Therefore, there exists a need for reinforced or composite membranes of desired thinness but still exhibiting good conductivity, power generation properties, temperature resistance (e.g., the ability to operate at elevated temperatures), mechanical strength, and resistance to dimensional change.

Nafion® is a perfluorosulfonic acid PFSA copolymer and it is considered an industry standard membrane material for use in PEM fuel cell applications. However, Nafion® has certain limitations and, for example, fuel cell developers/automobile manufacturers desire better conductivity and physical properties of the membrane to withstand operational conditions under a wide humidity range. In the fuel cell industry there has been a desire for having a membrane electrolyte, which possesses, both (a) dimensional stability and (b) mechanical integrity while operating under wide operational humidity ranges, especially under dynamic load cycling condition, and (c) high operational temperatures, while maintaining high proton conductivity necessary for maintaining good fuel cell performance.

Fuel cell applications may typically employ membranes with a thickness of 50-175 μm depending on the nature of the application. In order to achieve higher power density and to reduce membrane resistance, thinner membranes (<25 μm) are increasingly being used. Thin membranes offer substantial performance enhancement in fuel cells, but they may reduce the mechanical strength of the membrane and hence make the membrane weak. Under dynamic load cycling the thin membrane may break down due to its inability to handle frequent expansion and contraction cycles under wide ranges of humidity.

This problem becomes more evident when low equivalent weight (“EW”) PFSA (or hydrocarbon) ionomer is used to achieve higher fuel cell performance. Low EW ionomers possess higher concentrations of sulfonic acid and hence possess higher water uptake, leading to further decreases in mechanical properties of the membrane. Thus a low EW thin membrane may show very good performance, but their lowered mechanical strength makes them difficult to handle.

In order to solve the above-mentioned problem of mechanical stability in thin low EW membranes, a mechanically strong and chemically stable porous reinforcement support material, such as porous polytetrafluoroethylene (PTFE) is commonly being used. Incorporation of the porous reinforcement such as GORETEX® ePTFE (Ref. AIChE 1992, 38, 93) may improve the mechanical property of the composite membrane and allows the membrane to restrict its swelling and contraction under humidity cycles. Moreover, this porous reinforcement makes the thin membrane easy to handle during the fabrication of, for example, the membrane electrode assembly (MEA). Although the porous reinforcement matrix, such as porous ePTFE helps in improving the mechanical properties of the membrane, the presence of this non-conducting ePTFE layer in the membrane reduces the conductivity of the membrane. The conductivity of the ePTFE reinforced composite membrane is lower than that of the dense ionomeric cast membrane, such as DuPont Nafion® “NR212” membrane.

Without wishing to be bound by any particular theory and/or hypothesis, it is thought that much of the conductivity loss of the composite membrane happens due to the collapse of the porous ePTFE layer during the processing of the membrane. Besides the ePTFE collapse, the non-continuous or dead-end pores in ePTFE are also partly responsible for creating non-conducting capillaries along the thickness of the membrane. Moreover, often, large voids or “dead spaces” containing no ionomer material may be found in the central portion of the ePTFE reinforcement. All of these factors may lead to the conductivity loss of the composite membrane.

Research has been undertaken in the area of making electrolyte membranes reinforced by electrospun nanofiber porous substrates. (See, for example, Journal of Membrane Science 367 (2011) 296-305). Proton conductivities ranging from 0.03 to 0.08 (S/cm) were reported and compared to Nafion® 112 membrane. The proton conductivity (FIG. 8, page 303) was dependent on the degree of sulfonation (designated by the terms “S6.0NFPS”, S6.5NFPS″, etc. which referenced the quantity of sulfonating reagent used to sulfonate the parent PPO polymer to make “SPPO” (sulfonated poly(2,6-dimethylphenylene oxide).

However, in the above-referenced article the authors did not make a direct comparison to the conductivity of the neat ionomer in order to show the penalty in performance resulting from the inclusion of the electrospun nanofiber porous substrates. Looking to reference article number 48, (J. Membrane Sci., Vol. 348, 167-173 (2010)), the proton conductivity data for three SPPO membranes is reported in Table 1, page 172. The original SPPO membrane has a conductivity of 0.130 S/cm. After heat treating to crosslink the structure, the conductivity is 0.1275 S/cm.

Making a comparison of neat ionomer to reinforced membrane between these research articles it can be shown that the lowest value of the ratio of the conductivity of the reinforced membrane/neat polymer=0.03/0.13=0.23; or stated as a fraction, less than ¼. The highest value of the ratio of the conductivity of the reinforced membrane/neat polymer=0.08/0.1275=0.627; or, stated as a fraction, less than=⅔.

Other reported composite membranes also disclose significant loss of conductivity compared to the constituent ionomer. For example, Choi et al. (Journal of Power Sources, 180, (2008), 167-171) acknowledge a drop in conductivity of an order of magnitude in discussing a Nafion® impregnated electrospun polyvinylidene fluoride composite membrane (i.e. a conductivity of 1.55-2.25 mS/cm for the Nafion® impregnated electrospun polyvinylidene fluoride composite membranes compared to 32 mS/cm for the constituent Nafion® N115 ionomer). As described further herein, it is clear that such composite membranes are structurally different from those of the present invention, reported herein, which do not suffer a loss of conductivity compared to the constituent ion exchange polymer.

High proton conductivity is a critical parameter for proton exchange membranes in fuel cells. It would be desirable to obtain a composite membrane wherein the ratio of the conductivity of the reinforced membrane/neat polymer is greater than ⅔, or even more desirable to essentially not have to pay a conductivity penalty disproportionate to the amount of reinforcement (measured by volume fraction) due to the inclusion of the reinforcement.

### SUMMARY

The invention provides improved membranes, processes for making membranes that improves resulting properties such as through-plane conductivity, electrical output, swelling, and the like, under a wide variety of conditions of relative humidity and temperature, and with the presence of a porous reinforcement matrix.

The invention also provides composite membranes of desired thinness but still exhibiting good conductivity, power generation properties, temperature resistance (e.g., the ability to operate at elevated temperatures), mechanical strength, and resistance to dimensional change.

The invention provides a composite membrane wherein the ratio of the conductivity of the reinforced membrane/neat polymer is greater than ⅔, or, in other embodiments, the conductivity of the composite membrane is no less than the cationic conductivity of said at least one cation exchange polymer multiplied by an adjustment factor of 1-1.2 volume fraction of said nonwoven web material.

Many problems are solved and many improvements made by the present invention. Among them is elimination of the collapse/void issue of the porous reinforcement matrix which is obtained in accordance with the present invention because reinforcement material of the invention has the properties wherein it withstands the collapsing force during the evaporation of the solvent from the ionomer dispersion impregnated composite film.

In some embodiments the invention provides a composite polymeric cation exchange membrane, said membrane comprising (a) a nonwoven web material having a porosity of at least about 65% and a mean pore size no greater than 10 μm, and having opposing surfaces, (b) at least one cation exchange polymer impregnated between said opposing surfaces of said nonwoven web such that said at least one cation exchange polymer has a volume fraction of at least 40 percent at a midpoint between the opposing surfaces.

The invention provides processes for making such reinforced polymeric ion exchange membrane.

The invention provides processes for making such reinforced polymeric ion exchange membrane wherein lower cost reinforcement material and lower cost ionomer may be used while achieving good membrane performance.

The invention provides a composite polymeric ion exchange membrane, said composite membrane having opposing surfaces and comprising: (a) a porous nonwoven web material comprising non-conductive unconsolidated polymer fibers; and (b) at least one ion exchange polymer impregnated between said opposing surfaces of said composite membrane such that said at least one ion exchange polymer has a volume fraction that is substantially equivalent throughout the composite membrane and which volume fraction between the opposing surfaces is greater than 50 percent.

In an embodiment, the ion exchange polymer is a cation exchange polymer.

In an embodiment, the ion exchange polymer is an anion exchange polymer.

In an embodiment, the porous nonwoven web material has a porosity of at least about 65% and a mean pore size no greater than 10 μm.

In an embodiment, the web material is selected from the group consisting of polyimide, polyethersulfone (PES) and polyvinylidine fluoride (PVDF).

In an embodiment, the web material is selected from the group consisting of melt spun polymers and solution spun polymers.

In an embodiment, the composite polymeric ion exchange polymer comprises both a cation exchange polymer and an anion exchange polymer.

In an embodiment, the composite polymeric ion exchange membrane has an ionic conductivity of greater than 80 mS/cm.

In an embodiment, the ion exchange polymer additionally forms a neat layer free of said web material and in contact with at least one of the opposing surfaces of said web.

In an embodiment, the composite polymeric ion exchange membrane has a thickness in the range of 2 to 500 microns.

In an embodiment, the ion exchange polymer comprises a cation exchange polymer selected from ion exchange polymers including a highly fluorinated carbon backbone with a side chain represented by the formula —(O—CF₂CFRf)ₐ—(O—CF₂)_{b}—(CFR′f)_{c}SO₃M, wherein R_{f} and R′_{f} are independently selected from F, Cl or a perfluorinated alkyl group having 1 to 10 carbon atoms, a=0, 1 or 2, b=0-1, and c=0 to 6, and m is hydrogen, Li, Na, K or N(R₁)(R₂)(R₃)(R₄) and R₁, R₂, R₃, and R₄ are the same or different and are H, CH₃ or C₂H₅.

In an embodiment, the composite polymeric ion exchange membrane comprises an anion exchange polymer selected from the group consisting of:
(i) the at least partially fluorinated polyaromatic polymer backbone includes the repeating unit of Formula I:
   wherein
   A is a single bond, alkylene, fluoroalkylene, or an arylene that is optionally substituted with a halide, alkyl, fluoroalkyl and/or cation functional group;

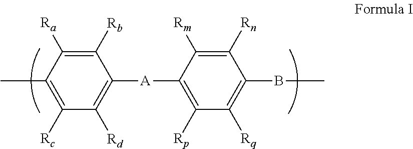

B is a single bond, oxygen or NR, wherein R is H, alkyl, fluoroalkyl or aryl, optionally substituted with halide, alkyl, a crosslinker and/or fluoroalkyl; and
Rₐ, Rb, Rₑ, Rd, Rm, Rn, Rp and R_{q} are each independently selected from the group consisting of hydrogen, fluorine, a crosslinking group and a cationic functional group; and
wherein at least one of A, B, Rₐ, Rb, R_{c}, Rd, Rᵢₘ R_{″}, Rₚ and R_{q} is fluorinated, and
(ii) the at least partially fluorinated polyaromatic polymer backbone includes the repeating unit of

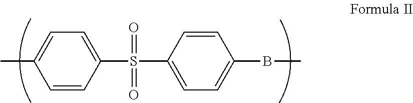

wherein B is a single bond, oxygen or NR, wherein R is H, alkyl, fluoroalkyl or aryl, optionally substituted with halide, alkyl, a crosslinker and/or fluoroalkyl.

In an embodiment, the ion exchange polymer has a volume fraction of at least 60 percent in the composite polymeric ion exchange membrane.

In an embodiment, the composite polymeric ion exchange membrane displays no through-plane conductivity loss (z-axis) due to the presence of said web in the membrane.

In an embodiment, the through-plane conductivity of the composite polymeric ion exchange membrane is at least 80% of that for the constituent unreinforced ion exchange polymer.

The invention also provides a flow battery comprising the composite polymeric ion exchange membrane of the invention.

The invention also provides a membrane electrode assembly comprising the composite polymeric ion exchange membrane of the invention and a fuel cell comprising said membrane electrode assembly.

The invention also provides a process to manufacture a composite polymeric ion exchange membrane having opposing surfaces, said process comprising the steps of:
(a) providing a solution or a dispersion comprising at least one ion exchange polymer,
(b) providing a porous nonwoven web material comprising non-conductive unconsolidated polymer fibers, and
(c) contacting said solution or dispersion with said web such that, when dry, said at least one ion exchange polymer is impregnated between the opposing surfaces of said nonwoven web and such that said at least one ion exchange polymer has a volume fraction that is substantially equivalent throughout the composite membrane and which volume fraction between the opposing surfaces is greater than 50 percent.

And the invention also provides said above process resulting in a composite polymeric ion exchange membrane having an ionic conductivity of greater than 80 mS/cm.

### DESCRIPTION OF THE FIGURES

FIG. 1 shows exemplary SEM micrographs for composite polymeric ion exchange membranes produced using consolidated web materials and using non-consolidated web materials, and shows the EDS traces for fluorine (F) and sulfur (S) corresponding to each composite sample.

FIG. 2 shows the cell voltage at a current density of 1 amp/cm² plotted as a function of cell temperature at 30% relative humidity (RH), and the results show the data for the inventive composite labeled as A, compared to the data for a commercial Nafion® XL membrane labeled as B.

FIG. 3 shows the fuel cell performance (voltage) at 1.2 A/cm2 for a reference dense membrane (ionomer) and unconsolidated PES composites containing the ionomer under different relative humidity conditions.

FIG. 4 shows the polarization curves (cell voltage vs. current density) obtained at 65° C. and 100% RH for inventive PES/Nafion® composite membranes of 1 mil thickness (A) and 3 mil thickness (C) and (D), as well as an ePTFE/Nafion® composite of 1 mil thickness (B).

FIG. 5 shows the swelling of an inventive PVDF composite membrane compared to a similar composite membrane using YEUMIFLON® PTFE Porous Membrane.

FIG. 6 shows the thru-plane conductivity of composite membranes and a reference membrane without reinforcement.

### DETAILED DESCRIPTION

Described herein is a process to prepare a polymer electrolyte membrane for an electrochemical cell, comprising: providing a reinforcing membrane, wherein the reinforcing membrane is a nanoweb that comprises a plurality of nanofibers, wherein the nanofibers may comprise in certain embodiments a fully aromatic polyimide, a polyethersulfone, or a polyvinylidene fluoride, and wherein the reinforcing membrane is not calendered or is lightly calendered; and impregnating the reinforcing membrane with an ion-exchange polymer.

The electrochemical cell can be any known in the art, such as fuel cells, batteries, chloralkali cells, electrolysis cells, sensors, electrochemical capacitors, and modified electrodes. The fuel cells can be anion or cation fuel cells, and can use any fuel source such as methanol or hydrogen.

The composite membrane described herein may be used in redox flow batteries as are described in U.S. Published Patent Application No. 2010/0003545. The redox flow battery stack designs described therein may be, for example, reactant combinations that include reactants dissolved in an electrolyte. One example is a stack containing the vanadium reactants V(II)/V(III) or V²⁺/V³⁺ at the negative electrode (anolyte) and V(IV)/V(V) or V⁴⁺/V⁵⁺ at the positive electrode (catholyte). The anolyte and catholyte reactants in such a system are typically dissolved in sulfuric acid. This type of battery is often called the all-vanadium battery because both the anolyte and catholyte contain vanadium species. Other combinations of reactants in a flow battery that can utilize the composite membrane in accordance with the invention are Sn (anolyte)/Fe (catholyte), Mn (anolyte)/Fe (catholyte), V (anolyte)/Ce (catholyte), V (anolyte)/Br₂ (catholyte), Fe (anolyte)/Br₂ (catholyte), and S (anolyte)/Br₂ (catholyte). Further examples of a workable redox flow battery chemistry and system are provided in U.S. Pat. No. 6,475,661, the entire contents of which are incorporated herein by reference.

### DEFINITIONS

Herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

For the purposes of the present invention, the term “membrane,” a term of art in common use in the fuel cell art is synonymous with the terms “film” or “sheet” which are terms of art in more general usage but refer to the same articles.

As used herein, the abbreviations “MD” and “TD”, for example as used with respect to descriptions of a cast membrane or extruded film, follow the convention of the art and are short for “machine direction” and “transverse direction”, respectively.

Herein, EW is short for Equivalent Weight and is the weight of the polymer (ionomer) in acid form required to neutralize one mole equivalent of NaOH. An ionomer is an ion exchange polymer.

Both nonwoven webs and nonwoven nanowebs as defined below are contemplated as within the scope of the invention.

The term “nanoweb” as applied herein refers to a nonwoven web constructed of a large fraction of nanofibers. Large fraction means that greater than 25%, even greater than 50% of the fibers in the web are nanofibers, where the term “nanofibers” as used herein refers to fibers having a number average diameter less than 1000 nm, even less than 800 nm, even between about 50 nm and 500 nm, and even between about 100 and 400 nm. In the case of non-round cross-sectional nanofibers, the term “diameter” as used herein refers to the greatest cross-sectional dimension. The nanoweb of the invention can also have greater than 70%, or 90% or it can even contain 100% of nanofibers.

Herein, a “non-consolidated” or “unconsolidated” web material is one that has not been compressed after manufacture, for example by calendaring, or by fixing or melt fusing polymer fibers together. “Calendering” is a process of compressing the web material, such as by passing a web through a nip between two rolls. Such rolls may be in contact with each other, or there may be a fixed or variable gap between the roll surfaces. Unconsolidated may include light calendaring at room temperature, or more preferably, no calendaring. In the present invention, any light calendaring must be mild enough to maintain a web material porosity of at least 65%, and preferably at least 70%, or at least 75%, and more preferably at least 80%, or at least 85%, or even greater than 90%.

Herein, the phrase (and similar phrases): “substantially all of the functional groups are represented by the formula —SO₃M wherein M is H” means that the percentage of such functional groups in the —SO₃H form approaches, or is, 100%, such as, for example, at least 98%.

The porosity of the nonwoven web material is equivalent to 100×(1.0−solidity) and is expressed as a percentage of free volume in the nonwoven web material structure wherein solidity is expressed as a fraction of solid material in the nonwoven web material structure.

“Mean pore size” is measured according to ASTM Designation E 1294-89, “Standard Test Method for Pore Size Characteristics of Membrane Filters Using Automated Liquid Porosimeter.” Individual samples of different size (8, 20 or 30 mm diameter) are wetted with a low surface tension fluid (1,1,2,3,3,3-hexafluoropropene, or “Galwick,” having a surface tension of 16 dyne/cm) and placed in a holder, and a differential pressure of air is applied and the fluid removed from the sample. The differential pressure at which wet flow is equal to one-half the dry flow (flow without wetting solvent) is used to calculate the mean pore size using supplied software.

“Bubble Point” is a measure of maximum pore size in a sample and is measured according to ASTM Designation F316, “Standard Test Methods for Pore Size Characteristics of Membrane Filters by Bubble Point and Mean Flow Pore Test.” Individual samples (8, 20 or 30 mm diameter) were wetted with the low surface tension fluid as described above. After placing the sample in the holder, differential pressure (air) is applied and the fluid is removed from the sample. The bubble point is the first open pore after the compressed air pressure is applied to the sample sheet and is calculated using vendor supplied software.

Non-conductive herein means non-conductive of cationic or anionic species, more typically hydrogen ions (protons).

### Nanofibers and Nanowebs Generally

Nanowebs may be fabricated by a process selected from the group consisting of electroblowing, electrospinning, and melt blowing. Electroblowing of polymer solutions to form a nanoweb is described in detail in Kim in World Patent Publication No. WO 03/080905, corresponding to U.S. Pat. No. 7,618,579, the disclosures of which are incorporated by reference herein in their entirety. The electroblowing process in summary comprises the steps of feeding a polymer solution, which is dissolved into a given solvent, to a spinning nozzle; discharging the polymer solution via the spinning nozzle, which is applied with a high voltage, while injecting compressed air via the lower end of the spinning nozzle; and spinning the polymer solution on a grounded suction collector under the spinning nozzle.

U.S. Pat. No. 7,618,579 discloses that suitable polymers for the processes described therein may include polyimide, nylon, polyaramide, polybenzimidazole, polyetherimide, polyacrylonitrile, PET (polyethylene terephthalate), polypropylene, polyaniline, polyethylene oxide, PEN (polyethylene naphthalate), PBT (polybutylene terephthalate), SBR (styrene butadiene rubber), polystyrene, PVC (polyvinyl chloride), polyvinyl alcohol, PVDF (polyvinylidene fluoride), polyvinyl butylene and copolymers or derivative compounds thereof. In embodiments of the invention, the nanofibers can comprise a fully aromatic polyimide, a polyethersulfone, or a polyvinylidene fluoride.

In an embodiment, the nanofibers consist essentially of one or more fully aromatic polyimides. For example, the nanofibers employed can be prepared from more than 80 wt % of one or more fully aromatic polyimides, more than 90 wt % of one or more fully aromatic polyimides, more than 95 wt % of one or more fully aromatic polyimides, more than 99 wt % of one or more fully aromatic polyimides, more than 99.9 wt % of one or more fully aromatic polyimides, or 100 wt % of one or more fully aromatic polyimides. As used herein, the term “fully aromatic polyimide” refers specifically to polyimides in which the ratio of the imide C—N infrared absorbance at 1375 cm⁻¹ to the p-substituted C—H infrared absorbance at 1500 cm⁻¹ is greater than 0.51 and wherein at least 95% of the linkages between adjacent phenyl rings in the polymer backbone are effected either by a covalent bond or an ether linkage. Up to 25%, preferably up to 20%, most preferably up to 10%, of the linkages can be affected by aliphatic carbon, sulfide, sulfone, phosphide, or phosphone functionalities or a combination thereof. Up to 5% of the aromatic rings making up the polymer backbone can have ring substituents of aliphatic carbon, sulfide, sulfone, phosphide, or phosphone. Preferably the fully aromatic polyimide suitable for use in the present invention contains no aliphatic carbon, sulfide, sulfone, phosphide, or phosphone.

Polyimide nanowebs suitable for use herein may be prepared by imidization of the polyamic acid nanoweb where the polyamic acid is a condensation polymer prepared by reaction of one or more aromatic dianhydride and one or more aromatic diamine. Suitable aromatic dianhydrides include but are not limited to pyromellitic dianhydride (PMDA), biphenyltetracarboxylic dianhydride (BPDA), and mixtures thereof. Suitable diamines include but are not limited to oxydianiline (ODA), 1,3-bis(4-aminophenoxy)benzene (RODA), and mixtures thereof. Typical dianhydrides include pyromellitic dianhydride, biphenyltetracarboxylic dianhydride, and mixtures thereof. Typical diamines include oxydianiline, 1,3-bis(4-aminophenoxy)benzene and mixtures thereof; more typically PMDA.and ODA.

In the polyamic acid nanoweb imidization process hereof, the polyamic acid is first prepared in solution; typical solvents are dimethylacetamide (DMAC) or dimethylormamide (DMF). In one suitable method, the solution of polyamic acid is formed into a nanoweb by electroblowing, as described in detail by Kim et al. in World Patent Publication No. WO 03/080905.

Imidization of the polyamic acid nanoweb so formed may conveniently be performed by first subjecting the nanoweb to solvent extraction at a temperature of ca. 100° C. in a vacuum oven with a nitrogen purge; following extraction, the nanoweb is then heated to a temperature of 200 to 475° C. for about 10 minutes or less, preferably 5 minutes or less, more preferably 2 minutes or less, and even more preferably 5 seconds or less, to sufficiently imidize the nanoweb. Preferably the imidization process comprises heating the polyamic acid (PAA) nanoweb to a temperature in the range of a first temperature and a second temperature for a period of time in the range of 5 seconds to 5 minutes to form a polyimide fiber, wherein the first temperature is the imidization temperature of the polyamic acid and the second temperature is the decomposition temperature of the polyimide.

The process hereof may furthermore comprise heating the polyamic acid fiber so obtained, to a temperature in the range of a first temperature and a second temperature for a period of time in the range of 5 seconds to 5 minutes to form a polyimide fiber or from 5 seconds to 4 minutes or from 5 seconds to 3 minutes, or from 5 seconds to 30 seconds. The first temperature is the imidization temperature of the polyamic acid. For the purposes of the present invention, the imidization temperature for a given polyamic acid fiber is the temperature below 500° C. at which in thermogravimetric (TGA) analysis performed at a heating rate of 50° C./min, the % weight loss/° C. decreases to below 1.0, preferably below 0.5 with a precision of ±0.005% in weight % and ±0.05° C. The second temperature is the decomposition temperature of the polyimide fiber formed from the given polyamic acid fiber.

In one suitable method, a polyamic acid fiber is pre-heated at a temperature in the range of room temperature and the imidization temperature before the step of heating the polyamic acid fiber at a temperature in the range of the imidization temperature and the decomposition temperature. This additional step of pre-heating below the imidization temperature allows slow removal of the residual solvent present in the polyamic acid fiber and prevents the possibility of flash fire due to sudden removal and high concentration of solvent vapor if heated at or above the imidization temperature.

The step of thermal conversion of the polyamic acid fiber to the polyimide fiber can be performed using any suitable technique, such as, heating in a convection oven, vacuum oven, infra-red oven in air or in inert atmosphere such as argon or nitrogen. A suitable oven can be set at a single temperature or can have multiple temperature zones, with each zone set at a different temperature. In an embodiment, the heating can be done step wise as done in a batch process. In another embodiment, the heating can be done in a continuous process, where the sample can experience a temperature gradient. In certain embodiments, the polyamic acid fiber is heated at a rate in the range of 60° C./minute to 250° C./second, or from 250° C./minute to 250° C./second.

In one embodiment, the polyamic acid fiber is heated in a multi-zone infra-red oven with each zone set to a different temperature. In an alternative embodiment, all the zones are set to the same temperature. In another embodiment the infrared oven further comprises an infra-red heater above and below a conveyor belt. In a further embodiment of the infrared oven suitable for use in the invention, each temperature zone is set to a temperature in the range of room temperature and a fourth temperature, the fourth temperature being at least 150° C. above the second temperature. It should be noted that the temperature of each zone is determined by the particular polyamic acid, time of exposure, fiber diameter, emitter to emitter distance, residual solvent content, purge air temperature and flow, fiber web basis weight (basis weight is the weight of the material in grams per square meter). For example, conventional annealing range is 400-500° C. for PMDA/ODA, but is around 200° C. for BPDA/RODA; BPDA/RODA will decompose if heated to 400° C. Also, one can shorten the exposure time, but increase the temperature of the infra-red oven and vice versa. In one embodiment, the fiber web is carried through the oven on a conveyor belt and goes though each zone for a total time in the range of 5 seconds to 5 minutes set by the speed of the conveyor belt. In another embodiment, the fiber web is not supported by a conveyor belt.

Nanofiber layers of Polyether Sulfone (PES) may be spun by electroblowing as described in WO 03/080905. PES (available through HaEuntech Co, Ltd. Anyang SI, Korea, a product of BASF) may be spun using a 25 wt % solution in a 20/80 solvent of N,N Dimethylacetamide (DMAc) (available from Samchun Pure Chemical Ind. Co Ltd, Gyeonggi-do, Korea), and N,N Dimethyl Formamide (DMF) (available through HaEuntech Co, Ltd. Anyang SI, Korea, a product of Samsung Fine Chemical Co). The polymer and the solution may be fed into a solution mix tank, and transferred to a reservoir. The solution may then be fed to the electro-blowing spin pack through a metering pump. The spin pack may have a series of spinning nozzles and gas injection nozzles. The spinneret may be electrically insulated and a high voltage be applied. Similar techniques may be employed to prepare nanofiber layers of polyvinylidene fluoride.

### Non Consolidated Material and Lightly Consolidated Material

In embodiments of the invention the nonwoven web material may comprise a porous layer of fine polymeric fibers having a mean diameter in the range of between about 50 nm and about 3000 nm, such as, for example, from about 50 nm to about 1000 nm, or from about 100 nm to about 800 nm, or from about 200 nm to about 800 nm, or from about 200 nm to about 600 nm, or, alternatively from about 1000 nm to about 3000 nm. In embodiments of the invention the nonwoven web material may be a nanoweb as previously defined. In embodiments of the invention, fine fibers in these ranges and the ranges set forth for nanowebs provide a nonwoven web material structure with high surface area which results in good ionomer absorption to provide the composite membrane in accordance with the invention.

In embodiments of the invention the nonwoven web material has a mean flow pore size of between about 0.01 μm and about 15 μm, even between about 0.1 μm and about 10 μm, even between about 0.1 μm and about 5 μm, and even between about 0.01 μm and about 5 μm or between about 0.01 μm and about 1 μm. These mean pore size values may be obtained after lightly calendaring the material at room temperature, or in the embodiment where no calendaring occurs, before imbibing with the cation or anion exchange polymer occurs.

In embodiments of the invention the nonwoven web material has a porosity of no less than 50%, and in other embodiments no less than 65%, or no less than 70%, or no less than 75%, and in other embodiments no less than 80% or 85%. These porosity values may be obtained after lightly calendaring the material at room temperature, or in the embodiment where no calendaring occurs, before imbibing with the cation or anion exchange polymer occurs. The high porosity of the nonwoven web material also provides for good ionomer absorption to provide the composite membrane in accordance with the invention.

A nonwoven web material useful in the composite membrane of the invention may have a thickness of between about 1 micron and 500 microns, or between about 2 microns and 300 microns, or between about 2 microns and 100 microns, or between about 5 microns and 50 microns, even between about 20 microns and 30 microns, even between about 10 microns and 20 microns, and even between about 5 microns and 10 microns. The nonwoven web material is thick enough to provide good mechanical properties while allowing good flow of ions.

The nonwoven web material has a basis weight of between about 1 g/m² and about 90 g/m², even between about 3 g/m² and about 45 g/m² or even between about 5 g/m² and about 40 g/m² or even between about 5 g/m² and about 30 g/m², and even between about 5 g/m² and about 20 g/m² or even between about 7 g/m² and about 20 g/m², or between about 7 g/m² and about 12 g/m² or between about 4 g/m² and about 10 g/m².

The nonwoven web material may have a Frazier air permeability of less than about 150 cfm/ft², even less than about 25 cfm/ft², even less than about 5 cfm/ft². In general, the higher the Frazier air permeability, the lower the ionic resistance of the nonwoven web material, therefore a nonwoven web material having a high Frazier air permeability can be desirable. However, other embodiments may be possible with low Frazier air permeability levels. At such low Frazier air permeability levels, i.e., about 1 cfm/ft² and less, the air permeability of a sheet material is more accurately measured as Gurley Hill porosity, and is expressed in seconds/100 cc. The approximate relationship of Gurley Hill porosity to Frazier air permeability may be expressed as:

Gurley Hill porosity (in. second)×Frazier (in. cfm/ft²)=3.1

In some embodiments of the invention, it is preferable to crosslink the polymer of the polymeric fine fibers in order to maintain the porous structure and improve the structural or mechanical integrity, the details of which are disclosed in U.S. Pat. No. 7,112,389, the entire disclosure of which is incorporated herein by reference.

In the process described herein, the as-produced nanoweb may or may not be further processed, for example by light calendering, before the impregnation with an ion-exchange polymer. “Calendering” is a process of compressing the nanoweb, such as by passing a web through a nip between two rolls. The rolls may be in contact with each other, or there may be a fixed or variable gap between the roll surfaces. In the instance where the nanoweb is lightly calendered before the impregnation with an ion-exchange polymer, such calendaring is done lightly or minimally, such that an optimum of (a) porosity, and/or (b) mean pore size and/or (c) maximum pore size is/are obtained as described below. Optionally, the nanoweb can also be calendared after impregnation.

Nip roll pressure to obtain light calendaring may be on the order of less than about 200 pounds per linear inch, or less than about 100 pounds per linear inch.

The objective, as mentioned above, is to retain the open pore structure and the porosity of the nanoweb material such that the impregnation and/or imbibing may take place and a fully imbibed nanoweb is obtained.

In embodiments of the invention the maximum pore size is from 0.8 μm to 20.0 μm. These maximum pore size values may be obtained after lightly calendaring the material, or in the embodiment where no calendaring occurs, before imbibing with the cation or anion exchange polymer occurs.

### Impregnation and/or Imbibing

Impregnation, also known as imbibing or absorbing, means that an ion-exchange polymer is absorbed by or taken into the nanoweb. The impregnation is typically performed by soaking the nanoweb in a solution of the ion-exchange polymer for a period of time sufficient to accumulate the desired concentration within the nanoweb. Alternatively, the ion-exchange polymer may be formed in-situ by impregnating the nanoweb with a solution of the corresponding monomer or low molecular weight oligomer.

The temperature and time at which the impregnation is performed can vary depending on many factors, such as the thickness of nanoweb, concentration of ion-exchange polymer in the above solution mixture, choice of solvent, and targeted amount of ion-exchange polymer in the nanoweb. The process can be conducted at any temperature above the freezing point of the solvent and typically up to 100° C.; more typically at up to 70° C. or at room temperature. Temperatures should not be so high as to cause fusion of polymer fibers.

A suitable ion exchange polymer, also known as an ionomer, is a polymer that has cation exchange groups that can transport protons or a polymer that has anion exchange groups that can transport anions, for example, hydroxyl ions.

The Volume Fraction Ionomer is the volume fraction of ionomer in the composite membrane at a given location (for example, the midpoint; or, alternatively, throughout the composite structure) and is equal to volume of ionomer/(volume of ionomer+volume occupied by the fibers in the non-woven substrate+volume of air+volume, if any, of additives including inorganic particles such as SiBCe)=the volume fraction of ionomer in the composite membrane at a given location. The volume fraction ionomer has no units as it is volume/volume which cancels, i.e., it is “unit-less”.

The volume fraction ionomer may be measured by considering volume elements as averages in the x,y plane over an area which has a statistically significant number of fibers. As can be determined by the worker with ordinary skill, the above-referenced statistically significant area will depend on the fiber diameter and other characteristics and may need to be adjusted to account for same, depending upon the particular sample. For example, if an area that is too small is chosen, e.g., equidistant between two fibers, it might only encompass ionomer and no fibers, and again give a misleading result of 100% ionomer. Accordingly, the chosen area for analysis should contain numerous fibers, and also be representative of the number of fibers in a similar area in another portion of the composite. Specifically, the volume fraction is visually analyzed from the pictures and graphs generated by using a Scanning Electron Microscope (SEM) [Hitachi S-4700 Cold Cathode Field Emission] with energy-dispersive X-ray spectroscopy (EDS) and Mapping capability. Preparation of the sample entailed embedding films in epoxy and cutting, grinding, and polishing once cured. Fluorine and sulphur elemental line-scans and elemental mapping were used.

In embodiments of the invention the volume fraction of ionomer is from 40%-90%, or from greater than 50% to 95%, or, in other embodiments, 60%-95%, or from preferably from 65% to 95% or from 70% to 95%, or from 75% to 95%, and in further embodiments 80%-95%. In embodiments of the invention the volume fraction of nonwoven membrane may be from 10%-60%, or from 5% to less than 50%, or from 5% to 40%, or 5% to 35%, or from 5% to 30%, or in other embodiments 5% to −25%, and in further embodiments 5%-20%. The volume fraction of air is negligible, e.g., it is substantially zero. Although some air volume may be present due to manufacturing or processing irregularities it is envisioned that in any event it is no greater than 0.1 volume %. The volume fraction of additives may be zero or up to 0.5% or more depending on the level of additives used. Any additives in accordance with the invention are added to the ionomer to incorporate them into the composite.

The composite polymer ion exchange membrane may have a thickness of from about 1 micron to 500 microns, or from about 2 microns to 300 microns, or from about 2 microns to 100 microns, or from about 5 microns to 50 microns, even from about 20 microns to 30 microns, even from about 10 microns to 20 microns, and even from about 5 microns to 10 microns.

### Cation Exchange Polymers

The cation exchange groups of the invention may be acids that can be selected from the group consisting of sulfonic, carboxylic, boronic, phosphonic, imide, methide, sulfonimide and sulfonamide groups. Typically, the ion exchange polymer has sulfonic acid and/or carboxylic acid groups. Various known cation exchange ionomers can be used including ionomeric derivatives of trifluoroethylene, tetrafluoroethylene, styrene-divinylbenzene, alpha, beta, beta-trifluorostyrene, etc., in which cation exchange groups have been introduced.

The cation exchange polymer may be selected from the group consisting of: (i) a resin that has a fluorine-containing polymer as the backbone and comprises a group such as a sulfonic acid group, a carboxyl group, a phosphoric acid group, or a phosphonate group; (ii) a hydrocarbon-based polymer compound or an inorganic polymer compound, or a partially fluorinated polymer compound containing both C—H and C—F bonds in the polymer chain and comprising a group such as a sulfonic acid group, a carboxyl group, a phosphoric acid group, or a phosphonate group or combinations thereof, and their derivatives; (iii) hydrocarbon-based polymer electrolytes including polyamide, polyacetal, polyethylene, polypropylene, acrylic resin, polyester, polysulfone, or polyether, into which an electrolyte group such as a sulfonic acid group, a carboxyl group, a phosphoric acid group, a phosphonate group or combinations thereof have been introduced, and their derivatives (aliphatic hydrocarbon-based polymer electrolyte); (iv) polystyrene into which an electrolyte group such as a sulfonic acid group, carboxyl group, a phosphoric acid group, a phosphonate group or combinations thereof have been introduced; (v) polyamide, polyamideimide, polyimide, polyester, polysulfone, polyetherimide, polyethersulfone, polycarbonate, etc., having an aromatic ring, into which an electrolyte group such as a sulfonic acid group, a carboxyl group, a phosphoric acid group, a phosphonate group or combinations thereof have been introduced, and their derivatives (partially aromatic hydrocarbon-based polymer electrolyte); (vi) polyether-etherketone, polyetherketone, polyethersulfone, polycarbonate, polyamide, polyamideimide, polyester, polyphenylene sulfide, etc., into which an electrolyte group such as a sulfonic acid group, a carboxyl group, a phosphoric acid group, a phosphonate group or combinations thereof have been introduced, and their derivatives (fully aromatic hydrocarbon-based polymer electrolyte); (vi) partially fluorinated polymer electrolytes including a polystyrene-graft-ethylenetetrafluoroethylene copolymer, polystyrene-graft-polytetrafluoroethylene copolymer, into which an electrolyte group such as a sulfonic acid group, a carboxyl group, a phosphoric acid group, a phosphonate group or combinations thereof have been introduced, and their derivatives; (viii) fully fluorinated polymer electrolyte (including Nafion® polymers); and (ix) sulfonimide.

Ion exchange polymers may preferably be highly fluorinated ion-exchange polymers or perfluorinated ion exchange polymers. However, other ion exchange polymer may be utilized such as partially fluorinated ionomers including ionomers based on trifluorostyrene, ionomers using sulfonated aromatic groups in the backbone, non-fluorinated ionomers including sulfonated styrenes grafted or copolymerized to hydrocarbon backbones, and polyaromatic hydrocarbon polymers possessing different degrees of sulfonated aromatic rings to achieve the desired range of proton conductivity. “Highly fluorinated” means that at least 90% of the total number of univalent atoms in the polymer are fluorine atoms. Most typically, the polymer is perfluorinated. It is typical for polymers used in fuel cell membranes to have sulfonate ion exchange groups. The term “sulfonate ion exchange groups” as used herein refers to either sulfonic acid groups or salts of sulfonic acid groups, typically alkali metal or ammonium salts. For applications where the ion exchange polymer is to be used for proton exchange as in fuel cells, the sulfonic acid form of the polymer is preferred. In this case, if the polymer is not in sulfonic acid form when used, a post treatment acid exchange step will be required to convert the polymer to acid form prior to use. Suitable perfluorinated sulfonic acid polymer membranes in acid form are available from E.I. du Pont de Nemours and Company, Wilmington, Del., under the trademark Nafion®.

The ion-exchange polymer may typically comprise a polymer backbone with recurring side chains attached to the backbone with the side chains carrying the ion-exchange groups. Possible polymers include homopolymers or copolymers of two or more monomers, or blends thereof. Copolymers are typically formed from one monomer which is a nonfunctional monomer and which provides carbon atoms for the polymer backbone, and a second monomer that provides both carbon atoms for the polymer backbone and also contributes a side chain carrying the cation exchange group or its precursor, e.g., a sulfonyl halide group such as a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidene fluoride, trifluoroethylene, chlorotrifluoroethylene, perfluoro (alkyl vinyl ether), and mixtures thereof. Possible second monomers include a variety of fluorinated vinyl ethers with sulfonate ion exchange groups or precursor groups which can provide the desired side chain in the polymer. The first monomer may also have a side chain which does not interfere with the ion exchange function of the sulfonate ion exchange group. Additional monomers can also be incorporated into these polymers if desired. The sulfonic acid form of the polymer may be utilized to avoid post treatment acid exchange steps.

Typical polymers for use as ion exchange polymers include a highly fluorinated, most typically a perfluorinated, carbon backbone with a side chain represented by the formula —(O—CF₂CFRf)ₐ—(O—CF₂)_{b}—(CFR′f)_{c}SO₃M, wherein R_{f} and R′_{f} are independently selected from F, Cl or a perfluorinated alkyl group having 1 to 10 carbon atoms, a=0, 1 or 2, b=0-1, and c=0 to 6, and M is hydrogen, Li, Na, K or N(R₁)(R₂)(R₃)(R₄) and R₁, R₂, R₃, and R₄ are the same or different and are H, CH₃ or C₂H₅. Preferably, substantially all of the functional groups are represented by the formula —SO₃M wherein M is H. Specific examples of suitable polymers include those disclosed in U.S. Pat. Nos. 3,282,875; 4,358,545; and 4,940,525. One exemplary polymer comprises a perfluorocarbon backbone and a side chain represented by the formula —O—CF₂CF(CF₃)—O—CF₂CF₂SO₃H. Such polymers are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging to convert to the acid, also known as the proton form.

Another ion-exchange polymer of the type disclosed in U.S. Pat. Nos. 4,358,545 and 4,940,525 has a side chain —O—CF₂CF₂SO₃H. The polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange.

For perfluorinated polymers of the type described above, the ion exchange capacity of a polymer can be expressed in terms of ion exchange ratio (IXR). Ion exchange ratio is defined as number of carbon atoms in the polymer backbone in relation to the number of ion exchange groups. A wide range of IXR values for the polymer are possible. Typically, however, the IXR range for perfluorinated sulfonate polymer is about 7 to about 33. For perfluorinated polymers of the type described above, the cation exchange capacity of a polymer can be expressed in terms of equivalent weight (EW). Equivalent weight (EW), as used herein, is the weight of the polymer in acid form required to neutralize one mole equivalent of NaOH. For a sulfonate polymer having a perfluorocarbon backbone and a side chain —O—CF₂—CF(CF₃)—O—CF₂—CF₂—SO₃H (or a salt thereof), the equivalent weight range corresponding to an IXR of about 7 to about 33 is about 700 EW to about 2000 EW. Polymer electrolyte membranes, particularly for fuel cells, may also have incorporated within the membranes, or on their surfaces, catalytically active particles added to improve the durability of these membranes. These particles may be incorporated by imbibing into a membrane, may be added to dispersions of the polymers and then cast, or may be coated onto the surface of the polymer membranes.

The dispersions may contain additives and/or stabilizers. Stabilizers are effective against degradation of the membrane and/or the electrode with hydrogen peroxide (H₂O₂) radicals, which are generated during fuel cell operation. Additives are used to help reduce degradation of membranes over time. Additives such as cerium-modified boron silica, as disclosed in US Patent Application No. 2007-0212593-A1, can be used in the dispersions in order to manufacture membranes with a longer lifetime.

The polymer electrolyte membranes may also be chemically stabilized. As used herein “chemically stabilized” means that the fluorinated copolymer was treated with a fluorinating agent to reduce the number of unstable groups in the copolymer. Chemically stabilized polymers are described in GB 1,210,794. The —SO₂F groups of the copolymer had been hydrolyzed and acid exchanged to the —SO₃H form.

### Anion Exchange Polymers

Useful compositions to use as anion exchange polymers in accordance with the invention are disclosed in WO 2010/133,854, the entirety of which publication is hereby incorporated herein by reference. By “anion exchange polymers” as used herein, therefore, is meant an electrolytic material capable of permitting anion conduction, e.g. transport of hydroxide, carbonate, or bicarbonate anions from a first face of the membrane to a second face of the membrane. Commercially available anion exchange polymers and resins are available in both hydroxide or halide (typically chloride) forms and are used in industrial water purification, metal separation and catalytic applications.

Anion exchange polymers and resins may contain metal hydroxide-doped materials. A variety of polymers such as poly(ethersulfones), polystyrenes, vinyl polymers, poly(vinyl chloride) (PVC), poly(vinylidene fluoride) (PVDF), poly(tetrafluoroethylene) (PTFE), poly(benzimidazole), and poly(ethyleneglycol) (PEG) may be doped with a metal hydroxide.

As an alternative to certain disadvantages presented by the presence of metal hydroxides, a second type of anion exchange polymers have been developed which are absent of metal countercations to the desired hydroxide anions. These are permanently charged polymers comprising polymer-bound cations and hydroxide counterions. A number of solid alkaline membranes have been described that comprise polymer-bound cationic counterions to the hydroxide ions that may pass through the membrane during operation of the electrochemical cell. These include quaternary ammonium-containing solid alkaline membranes such as those containing monomers such as vinylbenzylchloride grafted onto fluoropolymers (see, for example, Danks et al., J. Mater. Chem., 13, 712-721 (2003); Herman et al., J. Membr. Sci., 218, 147-163 (2003); Slade et al., Solid State Ionics, 176, 585-597 (2005), and a cross-linked development of the lattermost (Varcoe et al., Chem. Commun., 1428-1429 (2006); Robertson et at, J. Am. Chem. Soc., 132, 3400-3404 (2010); and Sorensen, Hydrogen and Fuel Cells, Elsevier Academic Press, 2005, p 217). Also, there is described in WO 2009/007922 (Acta SpA) a thermoplastic-elastomeric biphasic matrix, comprising a chemically stable organic polymer grafted onto which are benzene rings bearing alkylene-linked pairs of quaternary ammonium ions, such as alkylene-linked 1,4-diazabicyclo[2.2.2]octane (DABCO), N,N,N′,N′-tetramethylmethylenediamine (TMMDA), N,N,N′,N′-tetramethylethylenediamine (TMEDA), N,N,N′,N′-tetramethyl, 3-propanediamine (TMPDA), N,N,N′,N′-tetramethyl-1,4-butanediamine (TMBDA), N,N,N′,N′-tetramethyl-1,6-hexanediamine (TMHDA) and N,N,H,N′-tetraethyl-1,3-propanediamine (TEPDA). Other polymer-bound quaternized ammonium ions that have been used include alkylated polymer-bound heterocycles such as pyridinium and imidazolium ions (see for example, Matsuoka, et. al. Thin Solid Films 516, 3309-3313 (2008) and Lin et. al. Chem. Materials 22, 6718-6725 (2010)).

In addition to solid alkaline membranes that comprise polymer-bound quaternary ammonium counterions to the hydroxide ions that may pass through the membrane during operation of the electrochemical cell, any OH— ion-containing polymer without metal counterions can be used as electrolyte or ionomer in such cells. One such example is tris(2,4,6-trimethoxyphenyl) polysulfone-methylene quaternary phosphonium hydroxide (TPQPOH) described by S Gu et al., Angew. Chem. Int. Ed., 48 (2009) 6499-6502).

An alkaline anion exchange membrane may be made by alkalising commercially available Morgane ADP100-2 (a cross-linked and partially fluorinated quaternary ammonium-containing anion exchange membrane sold by Solvay S.A., Belgium), as described by L A Adams et al., ChemSusChem, 1, (2008), 79-81).

Other solid alkaline membranes are based upon polystyrenes (see for example, Sata et. al., J. Membrane Science 112, 161-170 (1996)) and poly(ethersulfones) (see for example, Wang, et. al. Macromolecules 42, 8711-8717 (2009) and Tanaka, et. al. Macromolecules 43, 2657-2659 (2010)), optionally for example in which the polymeric backbones are cross-linked. Wang et al. (J. Membrane Science, 326, 4-8 (2009)) recently reported the preparation of an alternative membrane based upon a functionalized poly(etherimide) polymer for potential fuel cells applications. A further example of a solid alkaline membrane is a membrane blend developed by Wu et al. (J. Membrane Science, 310, 577-585 (2008)) as a result of the recognition of the advantageous hydrophobicity, high glass temperature, and hydrolytic stability of poly(2,6-dimethyl-1,4-phenylene oxide) (PPO). Chloroacetylated PPO(CPPO) and bromomethylated PPO (BPPO)) were blended and the blend subject to alkalisation to prepare a solid hydroxide-conducting anion-exchange membrane for use in direct methanol fuel cells. An example of an anion exchange membrane with a perfluorinated backbone was reported by Jung et. al. in J. Materials Chemistry 21, 6158-6160 (2011).

All of the immediately hereinbefore described anion exchange polymers have in common the ability to be derivatized whereby to provide permanently charged metal ion-free solid alkaline membranes.

Many commercially available anion exchange polymers are based on quaternary ammonium salts bound to polymers such as cross-linked polystyrene or styrene-divinyl benzene copolymers. In these, and other anion exchange polymers, the polymer-bound cationic counterions to the anions (e.g. hydroxide ions) may typically be introduced by reaction between halide-derivatized polymers and a tertiary amine followed by, for example alkalisation (introduction of hydroxide anions) by reaction with metal hydroxide solutions, e.g. of potassium or sodium hydroxide, with the resultant metal ion-contaminated membranes being satisfactorily rendered essentially metal ion-free by (typically) repeatedly washing with deionised water. An example is the alkaline quaternary ammonium-functionalised poly(ethersulfone) described as QAPS (quaternary ammonium polysulfone) by Lu et al. (Proc. Natl. Sci. USA, 105, 20611-20614 (2008)). The alkaline membrane such as A201, A901 developed by Tokuyama Corp, Japan (see Yanagi et. al., ECS Transactions, 16, 257-262 (2008)) and the FAA series membrane developed by FuMA-Tech GmbH, Germany (Xu, J. Membrane Science, 263, 1-29 (2005)) can be used in the fuel cells mentioned above.

In addition to solid alkaline membranes that comprise polymer-bound quaternary ammonium counterions to the hydroxide ions that may pass through the membrane during operation of the fuel cell, any OH— ion-containing polymer without metal counterions can be used as electrolyte or ionomer in the fuel cells. One such example is a quaternary phosphonium-bound poly(arylethersulfone) formed by reaction of a chloromethylated poly(arylethersulfone) with tris(2,4,6-trimethoxyphenyl)phosphine as described by Gu et al., Angew. Chem. Int. Ed., 48, 6499-6502 (2009). Other polymer-bound cationic groups that may be employed include guanidinium groups (see for example, Wang et. al. Macromolecules 43, 3890-3896 (2010)) as well as phosphazenium and sulfonium groups as disclosed by Pivovar and Thorn in U.S. Pat. No. 7,439,275.

Such metal-free, alkaline and permanently charged polymers and polymer blends may be used as the anion exchange polymer according to the present invention.

Useful compositions to use as anion exchange polymers in accordance with the invention are disclosed in WO 2011/038,198, the entirety of which publication is hereby incorporated herein by reference. In embodiments of the invention, anion exchange polymers are used that include at least partially fluorinated polyaromatic polymer backbone and at least one cationic functional group pendant therefrom. In some embodiments, the at least partially fluorinated polyaromatic polymer backbone includes the repeating unit of Formula I:

wherein

A is a single bond, alkylene, fluoroalkylene, or an arylene that is optionally substituted with a halide, alkyl, fluoroalkyl and/or cation functional group;

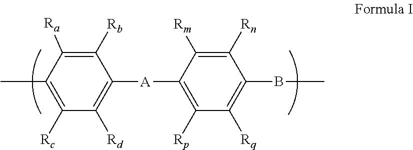

B is a single bond, oxygen or NR, wherein R is H, alkyl, fluoroalkyl or aryl, optionally substituted with halide, alkyl, a crosslinker and/or fluoroalkyl; and

Rₐ, R_{b}, Rₑ, R_{d}, Rₘ, Rₙ, Rₚ and R_{q} are each independently selected from the group consisting of hydrogen, fluorine, a crosslinking group and a cationic functional group; and

wherein at least one of A, B, Rₐ, R_{b}, R_{c}, R_{d}, Rᵢₘ R_{″}, Rₚ and R_{q} is fluorinated.

In some embodiments, the at least partially fluorinated polyaromatic polymer backbone includes a polysulfone repeating unit. In some embodiments, the at least partially fluorinated polyaromatic polymer backbone includes the repeating unit of

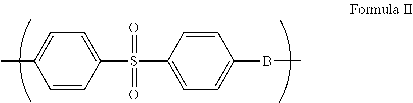

wherein B is a single bond, oxygen or NR, wherein R is H, alkyl, fluoroalkyl or aryl, optionally substituted with halide, alkyl, a crosslinker and/or fluoroalkyl.

For example, the fluorinated anion exchange polymer may include a repeating unit such as:

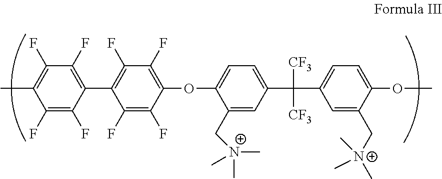

For example, the fluorinated anion exchange polymer may include a repeating unit such as:

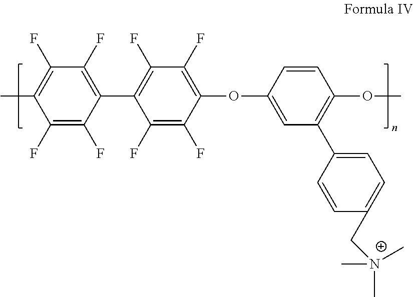

### EXPERIMENTAL

### Examples 1-5

### Preparation of Non-Woven Web Materials

Nanowebs were prepared from PMDA-ODA poly(amic acid) solutions in DMAC solvent. The electroblowing technique was used as described in U.S. Published Patent Application 2005/0067732. The nanoweb was then manually unwound and cut with a manual rolling blade cutter into hand sheets approximately 12″ long and 10″ wide. Following the preparation of nanoweb, the specimens of PAA nanofibers were then heated by placing the sample on a metal tray lined with Kapton® film and then placing the tray with the sample on it in a laboratory convection oven which was heated from room temperature to 350° C. at 5° C./minute. For the polyimide nanoweb of Example 5, the imidization was performed with three successive heat treatments of 200° C., then 300° C., then 500° C., each treatment being two minutes each. The polyimide nanowebs were optionally lightly calendered before imidization between a hard steel roll and a cotton covered roll at about 100 pounds per linear inch on a BF Perkins calender.

Nanowebs were also made by electroblowing solutions of p(VDF-HFP), a copolymer of vinylidene fluoride and hexafluoropropylene (Kynar Flex® 2801) (Arkema)

The basis weights (g/m²) for nanowebs of Examples 1-5, and for comparative expanded polytetrafluoroethylene (ePTFE) reinforcement webs, were determined by weighing, to 0.0001 g, rectangular pieces of the reinforcement web with known area. The thicknesses were measured to 1 μm accuracy using a micrometer and gage stand (Ono Sokki EG-225 & ST-022). In the case of ePTFE reinforcements, a flat tip of ˜1 cm diameter was fitted to the micrometer. This had the effect of spreading the force of the spring of the micrometer spindle over a larger area of the reinforcement, lowering the contact pressure, and minimizing compression of the reinforcement while measuring its thickness. Porosities of the reinforcements were calculated using values 1.76 g/cm³ for the density of p(VDF-HFP), 1.42 g/cm³ for the density of the polyimide, and 2.20 for the density of PTFE.

Porosity=100%×[1−(basis wt/(thickness×polymer density))]

Samples were prepared with variations in heating and calendering, and the properties were measured, shown below in Table 1. In Table 1, the porosities are those for the web material before any calendaring.

TABLE 1
Properties of web material

| | Substrate | Basis | Thickness | |
|---|---|---|---|---|
| Example | material | wt. g/m² | μm | Porosity % |
| Comparative A | PTFE (Phillips | 12.8 | 57 | 90% |
| | Scientific XTM) | | | |
| Comparative B | PTFE | 7.5 | 16 | 79% |
| | (Tetratex ® | | | |
| | 1326) | | | |
| Comparative C | PTFE | 4.8 | 14 | 84% |
| | (Tetratex ® | | | |
| | AX07) | | | |
| 1 | p(VDF-HFP) | 10.3 | 42 | 86% |
| | consolidated | | | |
| 2 | Polyimide, | 20.3 | 58 | 75% |
| | consolidated | | | |
| 3 | Polyimide, | 4.9 | 12 | 71% |
| | lightly | | | |
| | consolidated | | | |
| 4 | Polyimide, not | 5.3 | 11 | 66% |
| | consolidated | | | |
| 5 | Polyimide, not | 4.4 | 11 | 72% |
| | consolidated | | | |

### Example 6

### Preparation of Composite Membrane

An ionomer was made by polymerizing tetrafluoroethylene together with 3-oxa-5-fluorosulfonylperfluoro-1-pentene using techniques described in U.S. Pat. No. 5,182,342. The equivalent weight (EW) of the ionomer was 737. The polymer in —SO₂F form was fluorinated using the process of patent document GB1210794(A), using elemental fluorine, in order to reduce carbonyl containing impurities. The polymer was hydrolyzed with KOH/ethanol/water, acidified with nitric acid, and dispersed in ethanol/water medium using the techniques described in U.S. Pat. No. 4,433,082. The ethanol was solvent exchanged to n-propanol (nPA), giving an ionomer dispersion consisting of 13% polymer, 33% nPA, and 54% water.

A casting dispersion was made by mixing together:
10.5 g of the ionomer dispersion (ionomer A)
2.52 g n-propanol
1.98 g water
0.501 g of a 10.9% suspension of ceria modified boron-coated silica particles as described in US Patent Appl. 20070213209.

The casting dispersion had a polymer concentration of 8.8% and an n-propanol concentration of 38%. It was stirred for 2 hours with a magnetic stir bar at 300 rpm.

A piece of membrane was first taped to the top edge of a 16″×12″ vacuum plate, and draped out of the way. A piece of Kapton® (E.I. du Pont de Nemours and Company, Wilmington, Del.) film (10″×8″×5-mil) was placed in the center of the plate. The dispersion was cast onto the Kapton®, using a doctor blade (Paul N. Gardner, 8-path applicator wet film applicator, 2″ wide gate) with 15 mil gate height. By hand, the bottom two corners of the polyimide membrane were pulled tight to eliminate wrinkles, but without stretching it, and then the polyimide membrane was lowered onto the coating. The vacuum holes outside the Kapton® held the polyimide membrane in place. The dispersion wetted the polyimide membrane. Without waiting for the first coating to dry, a second coating of dispersion was applied over the polyimide membrane, but using a 20 mil gate height.

The Kapton®+membrane was transferred to an aluminum plate mounted on a hot plate. The hot plate had been preheated so that the aluminum plate was at 80° C. A plastic box was placed over the hot plate and a slow flow of nitrogen was introduced through holes in tubes running about the inside base of the box. The coating was dried for 30 min on the hot plate. The Kapton®+membrane was coalesced in a mechanical convection oven for 5 min at 170° C. The membrane was peeled from the Kapton® with the assistance of a bead of water at the peeling line.

Swelling Measurement—Strips were punched out from the membrane using a 10 mm×50 mm die, with the long direction parallel to either the MD or TD direction of the membrane. A strip was first boiled in water for 30 minutes, then placed between polyethylene sheets to prevent water evaporation, and cooled to ambient temperature. The length of the membrane, along the long direction, was marked on the PE sheet, and then the distance between the two marks on the PE sheet measured to give a wet (swollen) length Lw. The strip was placed between coarse Teflon® mesh and dried in a vacuum oven with nitrogen purge at 100° C. for 45 min. After removal, the length of the strip was quickly measured at ambient to give a dried length Ld. The swelling was calculated as

$$Swelling = 100 \% x \begin{matrix}\begin{matrix}x {L}_{w} - \\ {L}_{d}\end{matrix} \\ {L}_{d}\end{matrix}$$

In some cases where the membrane curled up too much on boiling, the ends of the strip were held between two plastic clamps for the boiling, drying, and measurement steps. For determining the lengths, the clamps were pulled apart sufficiently to remove wrinkles from the membrane strip, and the distance between the center faces of the clamps was measured.

Conductivity measurements were made through-plane (current flows perpendicular to the plane of the membrane) using the technique described in patent document 2006/0178411(A1). The membranes were measured at ambient temperature (˜22° C.) after boiling in water using a ¼″ dia. gold-plated electrode, GDE interfaces to the membrane, and a Gamry FRA operating at 100 kHz.

The ionomer dispersion, without the modified silica particles and without reinforcement, was cast into a comparative membrane D. The p(VDF-HFP) nanoweb of Example 1 was used with similar ionomer dispersion and method to fabricate composite membrane 6A. Polyimide nanowebs of Example 3 and 4, which had lower basis weight than Ex. 2, were used with similar ionomer dispersions to fabricate composite membranes 6C and 6D. Comparative membranes were made using three types of ePTFE (Reinforcements A-C), which gave three levels of swelling. The conductivity and swelling for these membranes are compared in Table 2.

TABLE 2
Properties of Composite Polymeric Ion Exchange Membranes

| | Thick- | Thick- | Swelling | | Resistance |
|---|---|---|---|---|---|
| | ness | ness | TD | | boiled |
| | Dry | Boiled | dimension | Conductivity | 22° C. |
| Substrate | (μm) | (μm) | % | mS/cm | mohm cm2 |
| None | 33 | 55 | 49 | 211 | 26 |
| (Ionomer A) | | | | | |
| ePTFE | | 38 | 4.1 | 81 | 47 |
| Comp. Ex. A | | | | | |
| ePTFE | 20 | 28 | 15 | 103 | 27 |
| Comp. Ex. B | | | | | |
| ePTFE | | | 23.3 | 124 | |
| Comp. Ex. C | | | | | |
| p(VDF-HFP) | 30 | 36 | 23 | 50 | 73 |
| Ex. 1 | | | | | |
| PI nanoweb | 41 | 58 | 0.5 | 26 | 225 |
| Ex. 2 | | | | | |
| PI nanoweb | 15 | 26 | 2.6 | 82 | 32 |
| Ex. 3 | | | | | |
| PI nanoweb | 15 | 28 | 9.3 | 98 | 29 |
| Ex. 4 | | | | | |

The results indicate that there is a correlation between the desired conductivity and undesired swelling. At the level of either 80 mS/cm, or for 100 mS/cm, the membranes reinforced with the polyimide nanowebs have significantly lower swelling (2.6% and 9.3%) than comparative membranes reinforced with ePTFE (4.1% and 15.0%). Ionomer A has a high conductivity, and, as is normally seen, the conductivity of the composite polymeric ion exchange membranes is significantly lower than that of their constituent ionomer. However, also of note, the conductivity of the composite is affected according to whether the web material was consolidated prior to impregnating with ion exchange polymer.

Electrospun fibers are produced in a pile and do not present a uniform flat substrate; accordingly, it is the normal practice in the art to calendar the web material prior to use.

### Example 7

### Hydrolytic Stability Test

The nanoweb of Example 5 was used to fabricate a composite membrane using the same method as Example 6, except that the ionomer had an EW of 720, the dispersion was 9.3 wt % ionomer and contained 37% n-propanol. After addition of the modified silica and dilution with n-propanol and water, the casting dispersion had 6% solids and 50% n-propanol. The coalesced membrane was cut into 1.25″ strips along the MD. A control sample had no further treatment (denoted 0 h), while two of the strips were soaked in water at 80° C. water for 50 hours or 200 hours. The tensile properties of the strips were measured, with the results below:

| | Instron | | Break | |
|---|---|---|---|---|
| | thickness | Modulus | Stress | Break |
| | μm | Ksi | Ksi | strain % |
| 0 h | 20 | 66.11 | 4.77 | 28.64 |
| 50 h | 20 | 51.91 | 4.44 | 26.48 |
| 200 h | 20 | 62.96 | 4.70 | 27.80 |

It is known that without an acidic electrolyte present, polyimide is known to suffer loss of tensile properties in boiling water. Acid accelerates the hydrolysis, and 6-membered ring polyimides are more stable than 5-membered ones to acid hydrolysis. The measurements show that the polyimide-reinforced membrane of the present invention suffers little or no loss in mechanical properties up to 200 h, in contrast to the sulfonated polyimides using 5-membered rings which hydrolyze within 1 hour at 80° C. (as shown by Genies et al., 2001 Polymer, p 5097).

### Example 8

### Accelerated Fuel Cell Durability Test

Another membrane was made using the same ionomer dispersion used in Example 6 (ionomer A) and as reinforcement the polyimide nanoweb of Example 3. This was made into a membrane-electrode assembly (MEA) with ETEK ELAT® gas diffusion electrodes, and tested in an accelerated fuel cell durability test (OCV, 90 C, 30% RH feeds, H2/O2). The destruction of the perfluorinated ionomer was monitored by the appearance of fluoride in the FC exhausts, and quantitated as the fluoride emission rate (FER). In Table 3 below, the membrane is compared to a Nafion® XL reinforced with ePTFE (DuPont), and also with a comparative membrane prepared similar to the composite of ionomer A with ePTFE reinforcement B. The polyimide nanoweb membrane had a reasonably low FER.

TABLE 3
Fluoride Emission Rates for Composites

| Substrate | FER mmole/h/cm² |
|---|---|
| Nafion ® XL 1^{st} sample | 0.0012 |
| Nafion ® XL 2^{nd} sample | 0.0145 |
| TetraTex ® 1326 | 0.0014 |
| ePTFE, 16-μm | |
| Example 8 | 0.0037 |

### Example 9

### Fabrication of PES Reinforced Nafion® Composite Membranes

The polyethersulfone (PES) reinforced membranes (composite polymeric ion exchange membranes) were fabricated by impregnating (casting) the highly porous as-produced substrate with Nafion® PFSA polymer dispersion DE2020 (DuPont). The impregnation was done by using an adjustable doctor's blade on a sheet of glass covered with Teflon® FEP. Two passes of impregnation was used.

A membrane size of 4 inch×4 inch and 50 microns thick was fabricated as follows: The substrate was 80% porous and the Nafion® dispersion had a solids content of 23% and a ratio of 6.5 to 1

| | |
|---|---|
| Calculated volume of dispersion | 9.537 cc |
| Volume needed to fill 80% voids | 7.630 cc |
| Impregnation #1 | 3.815 cc |
| Knife #1 | 8.1 mils |
| Impregnation #2 | 3.815 cc |
| Knife #2 | 16.2 mils |

First an initial layer of the dispersion using Knife #1 was cast onto the FEP. The substrates were then placed into the initial cast layer of the dispersion. The doctor's knife was adjusted to the Knife #2 setting then impregnation #2 was drawn onto the top side of the substrates. The wet impregnated membranes were dried under nitrogen at room temperature. The dried membranes were then heat treated in a convection oven at 160° C. for 5 minutes. These samples are labeled Examples 9A and 9B.

PES membranes were also prepared as above using 22.23% solids ionomer of Nafion® PFSA polymer dispersion DE2020 (DuPont) and a reinforcing substrate of 76% porosity (29.9 g/m²) polyethersulfone, and labeled Examples 9C and 9D.

All basis weights were determined by weighing a piece of substrate which had been cut using a steel rule die punch measuring 62 mm×81 mm.

The PES membranes were tested for conductivity as described in Example 6, with the results shown in Table 4 below. Each test was repeated and the average calculated.

TABLE 4
Conductivity of Composite Membranes

| | | | Total | Circuit | | Through- | |
|---|---|---|---|---|---|---|---|
| | Membrane | Membrane | Resistance | Resistance | Area | Plane | |
| | Thickness | Thickness | At 100 KHz | at 100 KHz | Resistance | Conductivity | Average |
| Example | (MICRONS) | (MILS) | (ohms) | (ohms) | (ohm · cm²) | (mS/cm) | (mS/cm) |
| 9A | 94.0 | 3.70 | 0.47633 | 0.11471 | 0.11463 | 82.0 | |
| | 94.0 | 3.70 | 0.47318 | 0.11471 | 0.11363 | 82.7 | 82.4 |
| 9B | 101.1 | 3.98 | 0.48324 | 0.10926 | 0.11855 | 85.3 | |
| | 101.1 | 3.98 | 0.48493 | 0.10926 | 0.11909 | 84.9 | 85.1 |
| 9C | 95.8 | 3.77 | 0.44641 | 0.10234 | 0.10907 | 87.8 | |
| | 95.8 | 3.77 | 0.44888 | 0.10234 | 0.10985 | 87.2 | 87.5 |
| 9D | 87.4 | 3.44 | 0.41211 | 0.10440 | 0.09754 | 89.6 | |
| | 87.4 | 3.44 | 0.4223 | 0.10440 | 0.10077 | 86.7 | 88.2 |

The constituent ionomer (DE2020) typically shows a conductivity of ˜90-95 mS/cm, but was not measured at the time of the experiment. However, the conductivity of the composite polymeric ion exchange membrane is approaching that of the constituent ionomer.

### Example 10

### Comparison of Consolidated vs. Non-Consolidated Polyimide/Nafion Composite Membranes

Polyimide substrates were prepared as described in Example 1 and coated using the two pass technique with Nafion® PFSA polymer dispersion DE2020 as described in Example 11. The lower porosity consolidated samples were prepared by calendaring the PI through a nip composed of a steel roll directly contacting a cotton roll applying a pressure of 500 lb/linear inch at room temperature. The non-consolidated web materials had a porosity of ˜90%.

The conductivity was measured as described above, and the results are shown in Tables 5 and 6 below.

TABLE 5
Consolidated Substrate

| % Porosity | | |
|---|---|---|
| After | | Thru Plane |
| Calendaring | Coating solids % | Conductivity (mS/cm) |
| 49 | 23 | 23 |
| 62 | 12 | 55 |
| 62 | 23 | 50 |

TABLE 6
Non-Consolidated Substrate

| Basis Wt. | Coating | Thru Plane |
|---|---|---|
| (gm/m2) | solids % | Conductivity (mS/cm) |
| 10 | 23 | 98 |
| 11.3 | 23 | 88 |
| 15 | 23 | 80 |

The data show that the through plane conductivity is adversely affected by consolidating the fibers. A porosity of 62% and lower shows a significant drop in the conductivity compared to the constituent ionomer.

### Example 11

### Micro-Structure of Composite Membrane

The following compares the inability of the ion-exchange dispersion to completely penetrate the bulk of the consolidated composite membrane, limiting the conductivity, with the ability of the ion-exchange dispersion to completely penetrate the bulk of the non-consolidated composite membrane, increasing the conductivity. Examples 11A, B, and C are consolidated polyimide substrate membranes from Example 10 (having porosities after calendaring of 49%, 62% and 62%, respectively). Examples 11D and E are non-consolidated polyimide membranes prepared using the two pass technique as in Example 10 with Nafion® PFSA polymer dispersion DE2020 at 22.28% solids with a non-consolidated polyimide substrate (both with a porosity of 90%) having a basis weight of 11.3 g/m².

The examples were analyzed using sulfur and fluorine mapping. A Hitachi S-4700 Cold Cathode Field Emission Scanning Electron Microscope (SEM) with energy-dispersive X-ray spectroscopy (EDS) and mapping capability was used for analysis. The films were embedded in epoxy and were cut, ground, and polishing once cured. Elemental line-scans and elemental mapping were used.

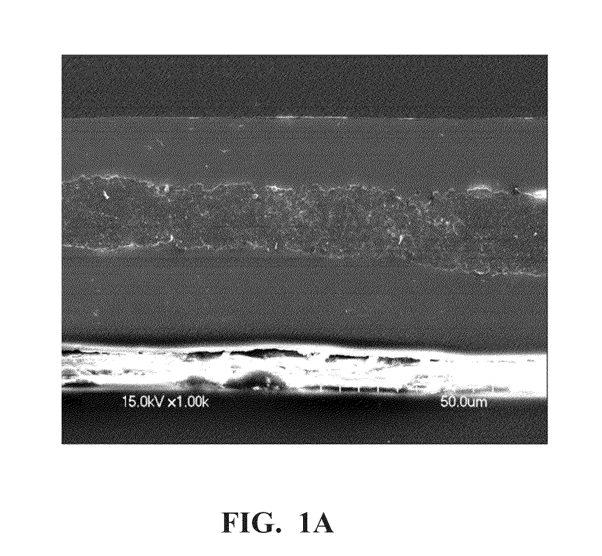

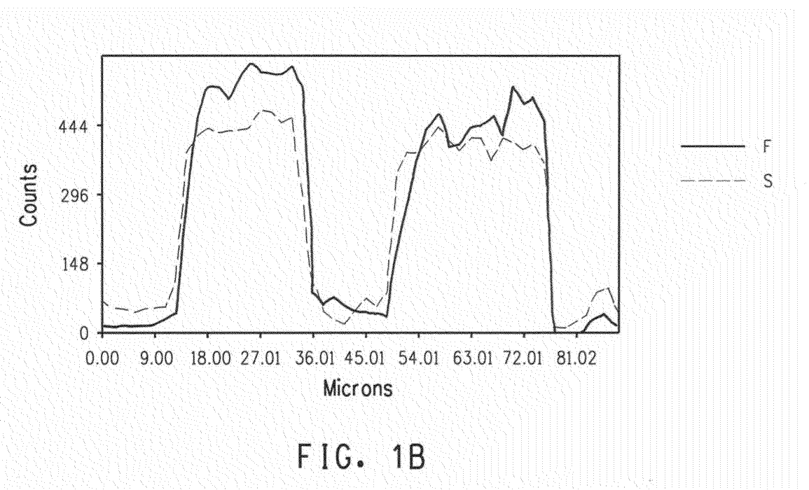

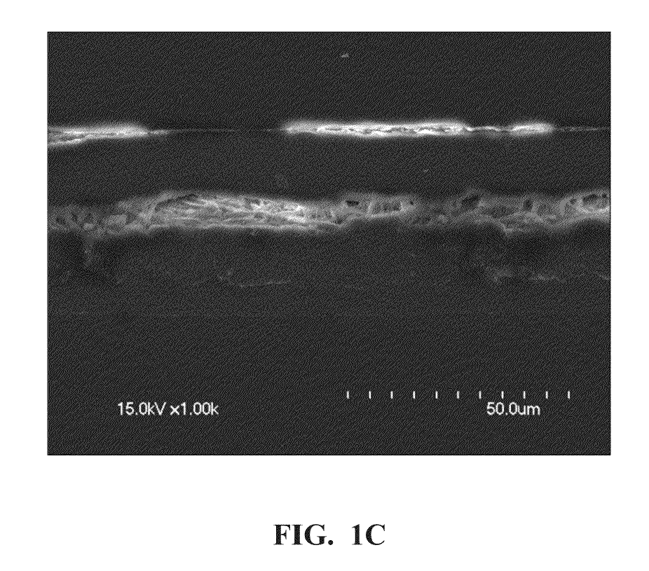

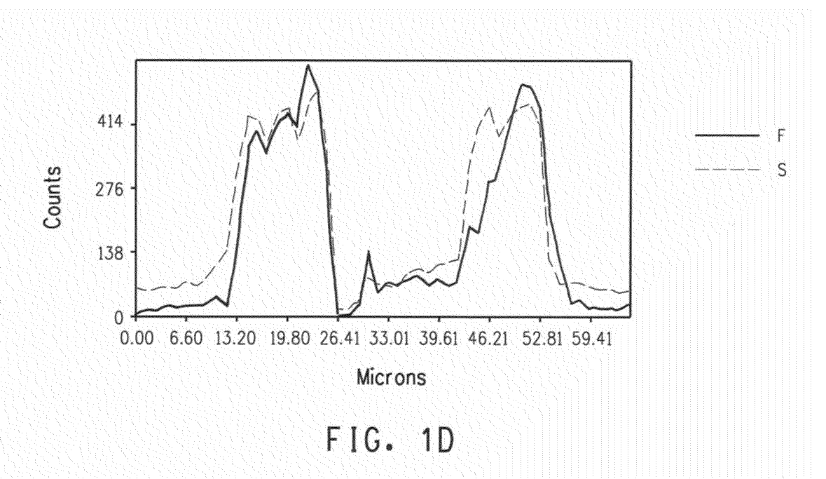

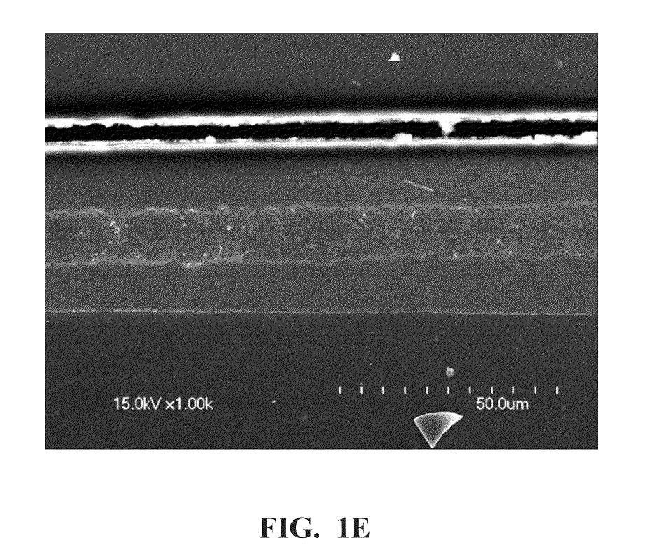

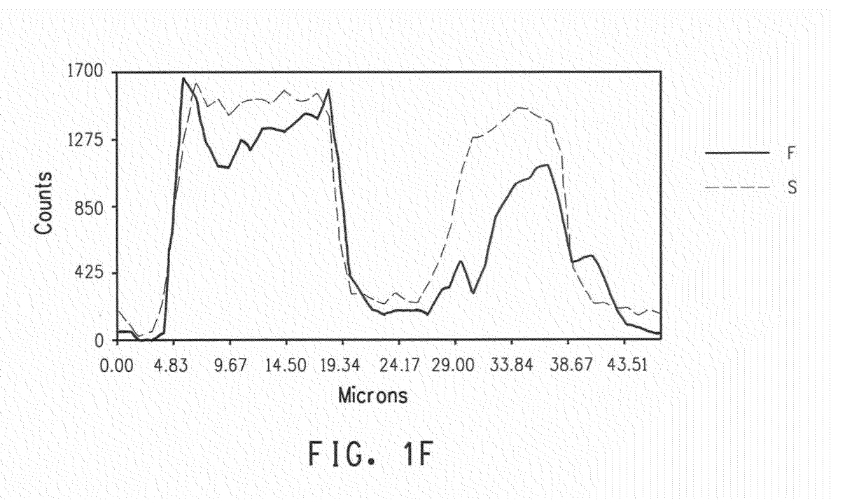

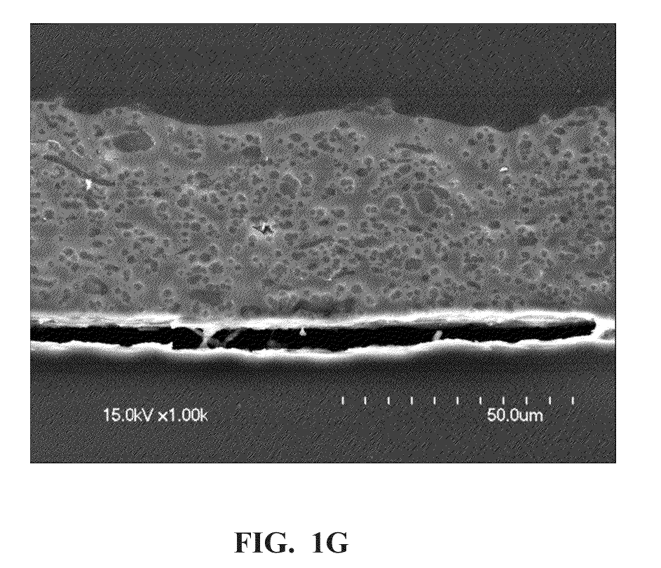

FIGS. 1A, 1C and 1E show exemplary SEM micrographs for composite polymeric ion exchange membranes produced using consolidated web materials, and FIGS. 1B, 1D and 1F show the EDS traces corresponding to these three samples, respectively. The graphs showing traces for F and S in the EDS indicate the level of fluorine and sulfur, respectively, across the cut cross-section of the membrane.

Similarly, FIGS. 1G and 1I show exemplary SEM micrographs for composite polymeric ion exchange membranes produced using non-consolidated web materials, and FIGS. 1H and 1J show the EDS traces corresponding to these two samples, respectively. Again, the graphs showing traces for F and S in the EDS indicate the level of fluorine and sulfur, respectively, across the cut cross-section of the membrane.

The EDS traces for FIGS. 1B, 1D and 1F show that minimal amounts of the perfluorosulfonic acid ionomer are present in the center of the reinforcement web material for the composites produced from the consolidated web material. Conversely, the EDS traces for FIGS. 1H and 1J show that the perfluorosulfonic acid ionomer is evenly distributed across the cut cross-section of the membrane and is, indeed, present in the center of the reinforcement web material for the composites produced from the non-consolidated web material. For the composites produced from the non-consolidated web material the ion exchange polymer has a volume fraction that is substantially equivalent throughout the composite membrane and the volume fraction between the opposing surfaces of the composite membrane is greater than 50 percent.

### Example 12

### Composite Polymeric Ion Exchange Membranes in Fuel Cell Application

A: 1 Mil PES+DE2029 Nafion® Dispersion+CeBSi: Nafion® XL

A fuel cell was prepared using a 1 mil highly porous as-produced PES substrate coated with Nafion® DE2029 PFSA polymer dispersion containing ceria modified boron-coated silica particles as described in Example 6. The catalyst coated membrane (CCM) was prepared as follows: A 4 inch×4 inch piece of dry membrane was sandwiched between one of the anode electrode decal (the decal was made by coating a catalyst ink prepared from TKK-TEC-10E50TPM mixed with DE2020 Nafion® dispersion onto a 5 mil Teflon® PFA film, the catalyst loading was 0.1 mg/cm2 Pt) on one side of the membrane and one of the cathode electrode decal (the decal was made by coating a catalyst ink prepared by mixing TKK-TEC-10E70 TPM and Nafion® PFSA DE2020 dispersion onto a 5 mil Teflon® PFA film, described above) on the opposite side of the membrane. Care was taken to ensure that the coatings on the two decals were registered with each other and were positioned facing the membrane. The entire assembly was introduced between two preheated (to about 150° C.) 8 inch×8 inch plates of a hydraulic press and the plates of the press were brought together quickly until a pressure of 5000 lbs was reached. The sandwich assembly was kept under pressure for approximately 2 minutes and then the press was cooled for approximately 2 minutes (viz. until it reached a temperature of <60° C.) under the same pressure. Then the assembly was removed from the press and the Teflon® PFA films were slowly peeled off the electrodes on both sides of the membrane.

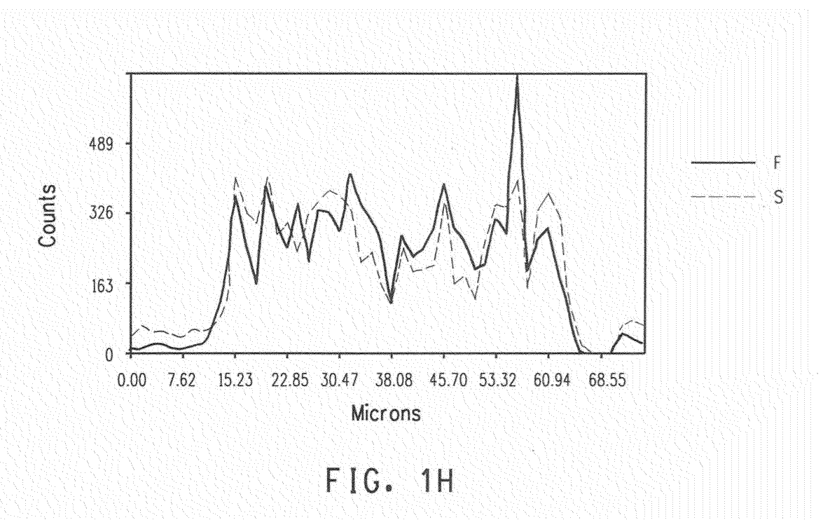

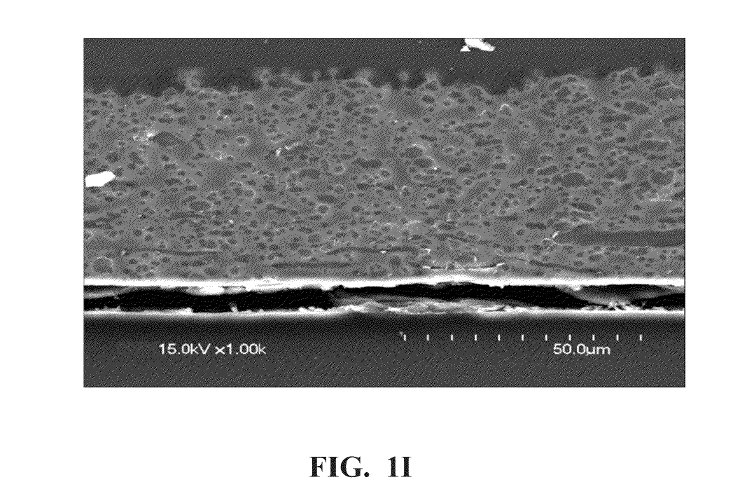

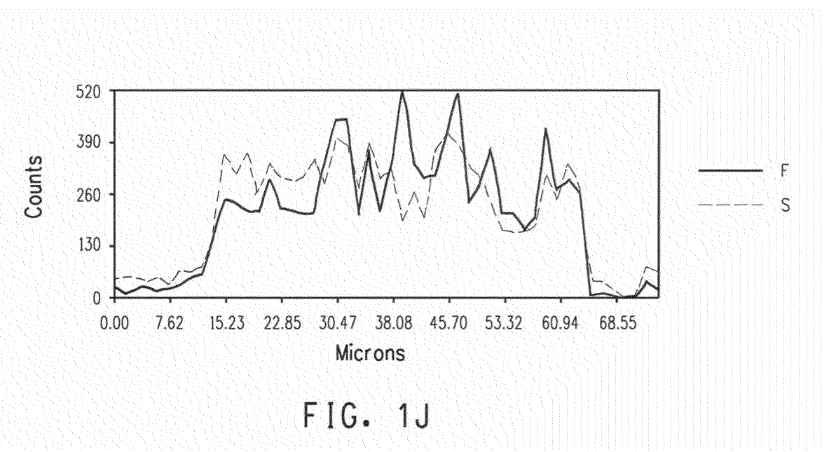

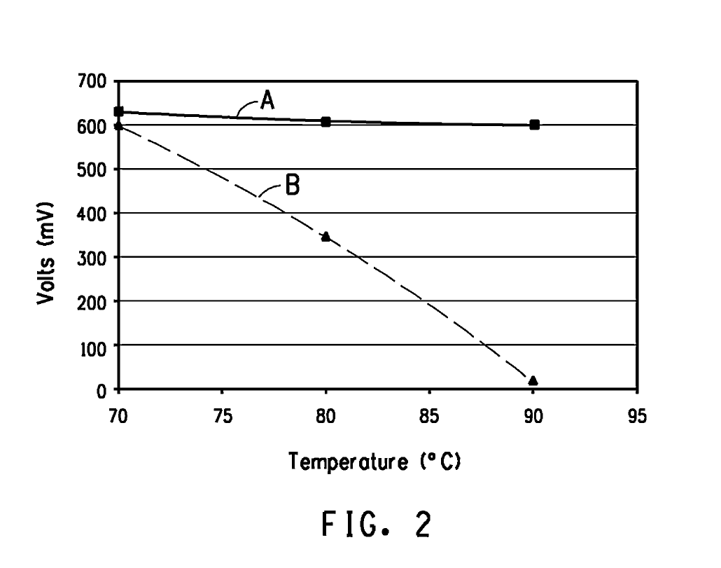

The fuel cell test was performed as follows: The fuel cell hardware used was made by Fuel Cell Technologies (Albuquerque, N. Mex.); the cell area was 25 cm² with Pocco graphite flow fields. The membrane electrode assemblies were made that comprised one of the above CCMs sandwiched between two sheets of the gas diffusion backing (taking care to ensure that the gas diffusion backing (“GDB”) covered the electrode areas on the CCM). SGL 31DC (SGL carbon group) was used as anode gas diffusion backing and the cathode diffusion backing was also SGL 31DC. The microporous layer on the anode-side GDB was disposed toward the anode and cathode catalyst. Two 9 mil thick Teflon® PFA polymer film gaskets each along with a 1 mil thick Teflon® PFA polymer spacer were cut to shape and positioned so as to surround the electrodes and GDBs on the opposite sides of the membrane and to cover the exposed edge areas of each side of the membrane. Care was taken to avoid overlapping of the GDB and the gasket material. The entire sandwich assembly was assembled between the anode and cathode flow field graphite plates of a 25 cm² standard single cell assembly. The test assembly was also equipped with anode inlet, anode outlet, cathode gas inlet, cathode gas outlet, aluminum end blocks, tied together with tie rods, electrically insulating layer and the gold plated current collectors. The bolts on the outer plates of the single cell assembly were tightened with a torque wrench to a force of 3 ft. lbs. The single cell assembly was then connected to the fuel cell test station and conditioned for 3 hours at 80° C. and atmospheric pressure with 100% relative humidity hydrogen and air being fed to the anode and cathode, respectively. The gas flow rate was two times stoichiometry, that is, hydrogen and air were fed to the cell at twice the rate of theoretical consumption at the cell operating conditions. During the conditioning process the cell was cycled between a set potential of 200 mV for 10 minutes and the open circuit voltage for 0.5 minutes, for a period of 3 hours. Then, the cell was kept at 800 mV for 10 minutes and the temperature was reduced to 65° C. After conditioning, the cell was tested for performance at 65° C. and atmospheric pressure with 100% relative humidity hydrogen and oxygen. Hydrogen was supplied to the anode at a flow rate equal to 1.25 stoichiometry. Filtered compressed air was supplied to the cathode at a flow rate to supply oxygen at 1.67 times stoichiometry. Eight polarization curves were taken, starting with the current density at 20 mA/cm², then 50 mA/cm², then 100 mA/cm², then 200 mA/cm², then 300 mA/cm², then 400 mA/cm² and then stepping up in 200 mA/cm² increments to 1200 mA/cm², recording the steady state voltage at each step. After testing the cell at 65° C. the cell was tested for performance at 70° C., 80° C. and 90° C. and atmospheric pressure with 30% relative humidity hydrogen and air. Hydrogen was supplied to the anode at a flow rate equal to 1.5 times stoichiometry. Filtered compressed air was supplied to the cathode at a flow rate to supply oxygen at 2 times stoichiometry (excess, i.e., twice the rate of theoretical consumption). FIG. 2 shows the cell voltage at a current density of 1 amp/cm² plotted as a function of cell temperature at 30% relative humidity (RH), and the results show the data for the inventive composite labeled as A, compared to the data for a commercial Nafion® XL membrane labeled as B. It can be seen that under low RH condition and higher temperature the performance of Nafion® XL100 drops significantly whereas the inventive PES membrane is relatively unchanged (see FIG. 2).

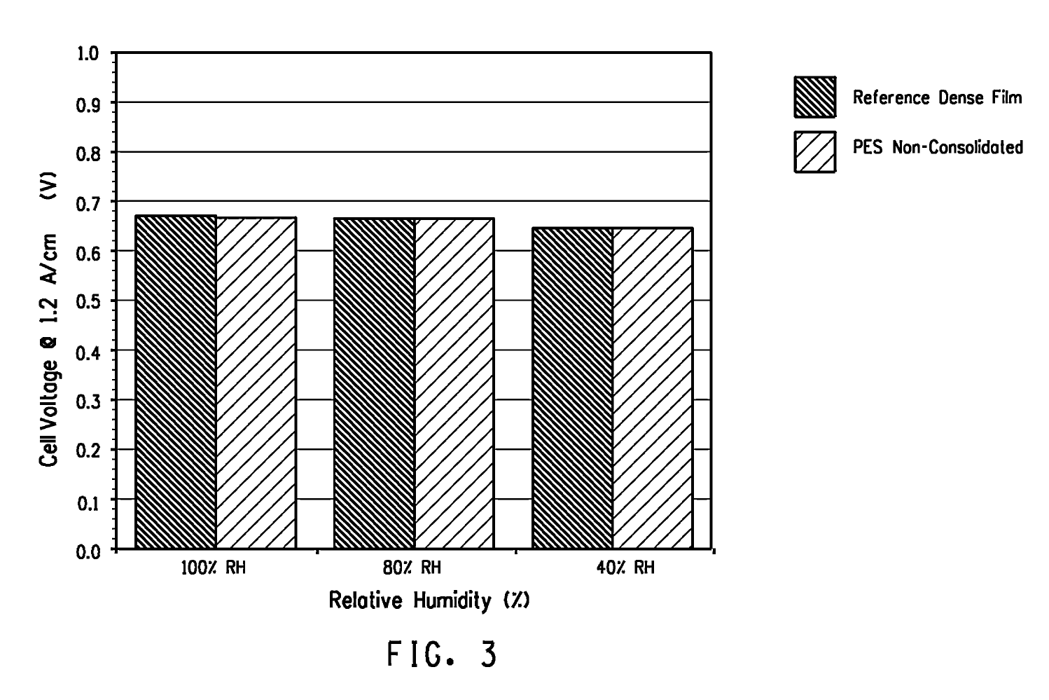

FIG. 3 shows the fuel cell performance (voltage) at 1.2 A/cm2 for the reference dense membrane (ionomer) and unconsolidated PES composites containing the ionomer under different relative humidity conditions. The composite polymeric ion exchange membrane produced from the unconsolidated PES behaves the same as the dense membrane in a fuel cell under different relative humidity conditions.

### Example 13

Example 12 was repeated using four membranes:
A: 1 mil PES composite ion exchange membrane of Example 12
B: 1 mil Nafion® XL
C: 3 mil PES substrate coated with Nafion® DE2029 PFSA polymer dispersion containing ceria modified boron-coated silica particles
D: 3 mil PES substrate coated with Nafion® DE2020 PFSA polymer dispersion containing ceria modified boron-coated silica particles

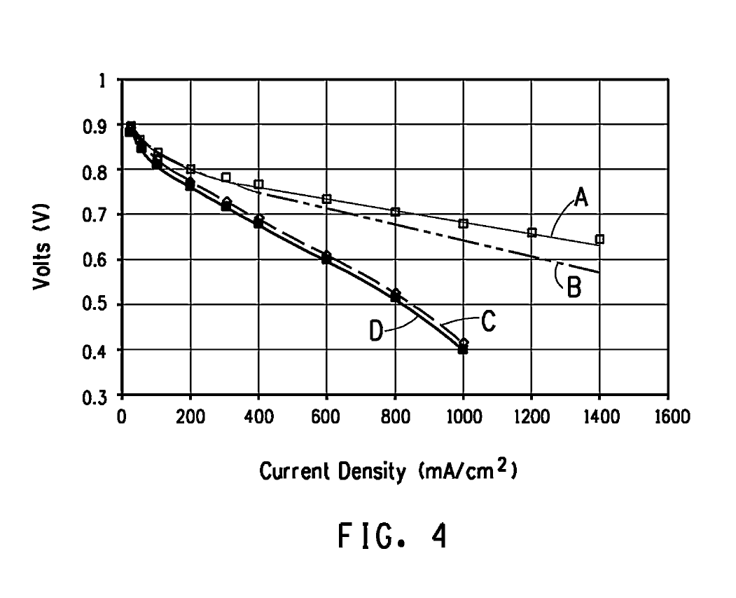

The polarization curves (cell voltage vs. current density) obtained at 65° C. and 100% RH (test details were as described in Example 12 above) are shown in FIG. 4. The data shows that the 1 mil PES/Nafion® (A) membrane based fuel cell has a significantly higher performance relative to Nafion® XL based fuel. The fuel cells based on 3 mil PES/Nafion® DE2029 dispersion and 3 mil PES/Nafion® DE2020 dispersion have similar performances but lower than Nafion® XL. See FIG. 4.

### Example 14

### Swelling and Conductivity of Composite Polymeric Ion Exchange Membranes

Nanowebs of PVDF (polyvinylidene fluoride, Kynar® 710, Arkema) and PES were prepared as described above and used as reinforcement substrates for composite polymeric ion exchange membranes, prepared as described below.

### Membrane Casting:

An 8″×10″ casting surface was assembled with a 2-mil Kapton® film that was water tacked to a glass substrate. The Kapton® tacked glass substrate was placed on an adjustable support table and leveled. The entire assembly was placed under a ventilated hood. A 10″ diameter circular piece of the PES or PVDF nanofiber porous reinforcement matrix was supported in an 8″ diameter embroidery hoop and kept aside. Standard ionomeric Nafion® PFSA dispersion DE2020 was used for making the composite membrane.

An 8″ wide casting knife with an adjustable blade was set up with a 0.008″ gap. The casting knife was lined up on the table approximately 0.75″ from the back end, facing forward. Approximately 10-mL of the dispersion mixture was carefully placed (avoiding entrained bubbles) on the table within the space defined by the casting knife blade and side supports. The knife was then drawn forward towards the front of the table. The prepared porous substrate in the embroidery hoop was centered on the table, was placed on the freshly cast dispersion and the dispersion was allowed to be soaked in the substrate. The embroidery hoop was removed and allowed to dry under stream of air for one hour. After one hour, the membrane was sufficiently dry and a second dispersion layer was applied in essentially the same manner as the first layer using a 6″ wide casting knife. The membrane was dried for one hour. The membrane, still attached to Kapton®, was placed in a convection oven and annealed at 150° C. for 3 minutes and then it was cooled in the hood for 30 minutes before peeling the composite membrane from Kapton® backing substrate.

### Swelling Measurement:

The swelling value for the composite membrane was determined using membrane strips punched out from the membrane using a 1″×3″ mm die along the direction parallel to MD and TD direction of the membrane. A punched out strip from MD was taken and it was conditioned in a humidity room (22° C., 50% RH) for 24 hrs. After conditioning the membrane strip, it was placed between polyethylene (PE) sheets and the length of the membrane strip along the long direction was marked on the PE sheet. The distance between these two marks was measured as the dry length Ld. After measurement of Ld, the membrane strip was boiled in deionized (DI) water for one hour and then it was cooled to ambient temperature by placing it between polyethylene (PE) sheets to prevent water evaporation during the cooling. The length of the membrane strip along the long direction was marked on the PE sheet and the distance between these two marks was measured as the wet (or swollen) length Lw. The membrane swelling was calculated using the formula below.

$$Swelling = \frac{( {L}_{w} - {L}_{d} )}{{L}_{d}} \times 100$$

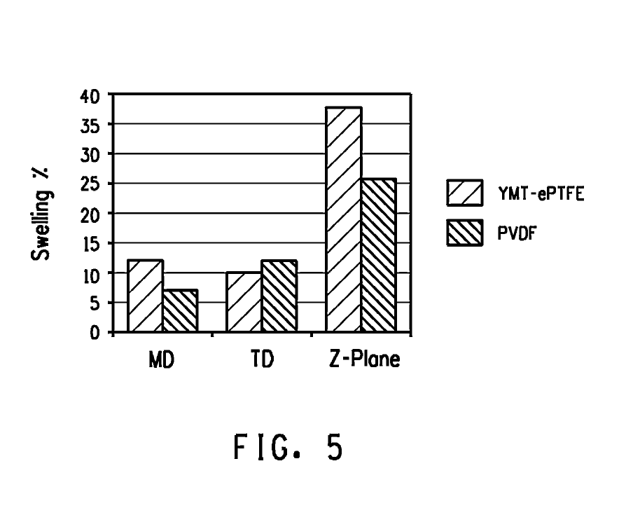

The swelling of the PVDF composite membrane was compared to a similar composite membrane using YEUMIFLON® PTFE Porous Membrane (YMT Chemical Industrial Co., Ltd., Taiwan). The results are shown in FIG. 5. The z-plane swelling of the non-consolidated polyvinylidene fluoride membrane is almost 20% less than that of the ePTFE based composite membrane (FIG. 5).

### Conductivity Measurement:

Conductivity measurements were made through-plane (current flows perpendicular to the plane of the membrane) and in-plane (current flows over the plane of the membrane) using the technique described below.

### In-Plane (X-Y Direction) Conductivity

The composite membrane sample was boiled in DI water for one hour and then a rectangular sample of 1.6 cm×3.0 cm was cut from the swollen membrane sample and placed in the conductivity fixture. The fixture was placed into a glass beaker filled with DI water. The membrane impedance was measured using Solotron SI-1260 Impedance Analyzer. The conductivity (κ) was determined using the following equation,

$$κ = \frac{1.00 cm}{( R \times t \times w )}$$

where, R is the membrane impedance, “t” is the membrane thickness and “w” is the membrane width. Both “t” and “w” is in cm.

### Through-Plane (Z-Direction) Conductivity

The through plane conductivity was measured by a technique in which the current flows perpendicular to the plane of the membrane. The GDE (gas diffusion electrode) was catalysed ELAT® (E-TEK Division, De Nora North America, Inc. Somerset, N.J.) comprising a carbon cloth with microporous layer, platinum catalyst and 0.6-0.8 mg/cm2 Nafion® application over the catalyst layer. The lower GDE was punched out as a 9.5 mm diameter disk, while the upper GDE was punched out as a 6.35 mm diameter disk. The composite membrane sample was boiled in DI water for one hour and then a circular sample with a diameter of 11.12 mm was punched out from the swollen membrane sample. The membrane sample was then sandwiched between lower and upper GDE's. The sandwiched stack was then clamped by applying a force of 270 N by means of a clamp and calibrated spring. The real part of AC Impedance of the membrane containing GDE sandwich, Rs was measured at a frequency of 100 kHz using Solotron SI-1260 Impedance Analyzer. The real part of AC Impedance of the GDE sandwich without membrane, Rf was measured at a frequency of 100 kHz as well. The conductivity (κ) of the membrane was calculated as,

$$κ = \frac{t}{( ( {R}_{s} - {R}_{f} ) \times 0.317 {cm}^{2} )}$$

where, “t” is the membrane thickness in cm.

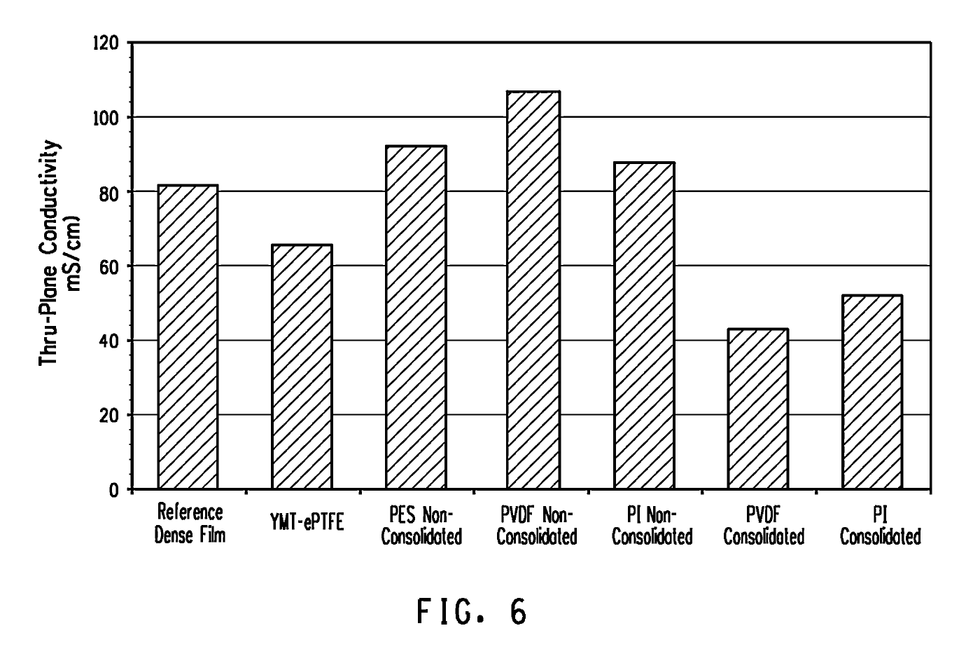

The conductivity of the PVDF and the PES composite membrane were compared to a similar composite membrane using YEUMIFLON® PTFE Porous Membrane (YMT Chemical Industrial Co., Ltd., Taiwan), labeled YMT-ePTFE, and to a reference membrane without reinforcement. The results are shown in the FIG. 6.

Use of a non-conductive reinforcement material is expected to result in a lower thru-plane conductivity as discussed earlier, and the ePTFE reinforced membrane indeed shows a significant reduction in conductivity compared to the reference Nafion membrane without reinforcement. Similarly, the composite polymeric ion exchange membranes produced from consolidated web material also show very significant decrease in conductivity compared to the reference Nafion membrane without reinforcement. However, the inventive non-consolidated composite polymeric ion exchange membranes show no decrease in conductivity. The porosities of the non-consolidated PVDF and PES web materials were 79% and 83%, respectively. The porosities of the consolidated PVDF and PES web materials, after consolidation, were 70% and 66%, respectively. The conductivities for the composites prepared from non-consolidated PVDF and PES web materials were much higher than those for the composites prepared from consolidated PVDF and PES web materials.

It should be noted that ePTFE is not made of non-woven fibers; the material is expanded and contains many dead ends in terms of pore space. Accordingly, ePTFE composites are not of the present invention, and do not attain the same high conductivities that are the feature of the present invention.

### Example Illustrating Electrospun Nanofiber Reinforced Nafion® Composite Membrane for Redox Flow Battery Applications

Perfluorosulfonic acid (PFSA) membranes, such as Nafion® may be used as a standard separator membrane in many different types of redox flow batteries (RFB), such as a Vanadium¹, an Iron-Chromium², a Hydrogen-Bromine³, a Sodium polysulfide-bromine⁴, and a Zinc-Bromine⁵ redox flow battery The high conductivity, good cationic selectivity and high chemical stability make Nafion® suitable for such battery applications.

The area conductivity of the membrane is an important parameter which shows the application feasibility of a membrane in RFB.

### In-Plane (X-Y Direction) Conductivity Measurement

The experimental composite membrane sample was boiled in DI water for one hour and then a rectangular sample of 1.6 cm×3.0 cm was cut from the swollen membrane sample and placed in the conductivity fixture. The fixture was placed into a glass beaker filled with DI water. The membrane impedance was measured using Solotron SI-1260 Impedance Analyzer. The conductivity (κ) was determined using the following equation,

$$κ = \frac{1.00 cm}{( R \times t \times w )}$$

where, R is the membrane impedance, “t” is the membrane thickness and “w” is the membrane width. Both “t” and “w” are in cm.

The area conductivity of the membrane of electrospun nanofiber reinforced Nafion® composite membrane was evaluated and compared to the membranes⁶⁻⁸ that are being used in RFB's. The membrane resistances are listed in the following table.

| | Area |
|---|---|
| | Resistance |
| Membrane Type | (Ω · cm²) |
| Nafion ® Nanofiber Matrix Composite (Present Invention) | 1.04 |
| Nafion ® 7 mil membrane (N117) | 1.06 |
| Sulfonated Daramic⁶ | 1.86 |
| Sulfonated AMV⁶ | 2.94 |
| Sulfonated polystyrene treated Daramic crosslinked with | 1.97 |
| DVB⁷ | |
| Carboxy methyl cellulose sodium treated Daramic crosslinked | 1.26 |
| with DVB⁷ | |
| Amberlite ® CG400 treated Daramic crosslinked with DVB⁷ | 2.20 |
| Daramic ™ Nafion ® Composite⁸ | 2.40 |

¹Journal of Membrane Science 1992, 75, 81.
²Journal of Power Sources 1992, 39, 147
³Journal of Power Sources 1988, 22, 293
⁴Electrochemical Acta 2005, 51, 1091.
⁵Journal of Electrochemical Society 1977, 124, 1154
⁶Journal of Membrane Science 1996, 107, 35.
⁷Journal of Membrane Science 1992, 75, 81.
⁸Journal of Membrane Science 2004, 234, 51.

What is claimed is:

1. A composite polymeric ion exchange membrane, said composite membrane having opposing surfaces and comprising:
(a) a porous nonwoven web material comprising non-conductive unconsolidated polymer fibers; and
(b) at least one ion exchange polymer impregnated between said opposing surfaces of said composite membrane such that said at least one ion exchange polymer has a volume fraction that is substantially equivalent throughout the composite membrane and which volume fraction between the opposing surfaces is greater than 50 percent.

2. The composite polymeric ion exchange membrane of claim 1 wherein the ion exchange polymer is a cation exchange polymer.

3. The composite polymeric ion exchange membrane of claim 1 wherein the ion exchange polymer is an anion exchange polymer.

4. The composite polymeric ion exchange membrane of claim 1 wherein the porous nonwoven web material has a porosity of at least about 65% and a mean pore size no greater than 10 μm.

5. The composite polymeric ion exchange membrane of claim 1 wherein said web material is selected from the group consisting of polyimide, polyethersulfone (PES) and polyvinylidine fluoride (PVDF).

6. The composite polymeric ion exchange membrane of claim 1 wherein said web material is selected from the group consisting of melt spun polymers and solution spun polymers.

7. The composite polymeric ion exchange membrane of claim 1 comprising both a cation exchange polymer and an anion exchange polymer.

8. The composite polymeric ion exchange membrane of claim 1 having an ionic conductivity of greater than 80 mS/cm.

9. The composite polymeric ion exchange membrane of claim 1 wherein said ion exchange polymer additionally forms a neat layer free of said web material and in contact with at least one of the opposing surfaces of said web.

10. A flow battery comprising the composite polymeric ion exchange membrane of claim 1.

11. A membrane electrode assembly comprising the composite polymeric ion exchange membrane of claim 1.

12. A fuel cell comprising the membrane electrode assembly of claim 11.

13. The composite polymeric ion exchange membrane of claim 1 having a thickness in the range of 2 to 500 microns.

14. The composite polymeric ion exchange membrane of claim 2 wherein said ion exchange polymer comprises a cation exchange polymer selected from ion exchange polymers including a highly fluorinated carbon backbone with a side chain represented by the formula —(O—CF₂CFRf)ₐ—(O—CF₂)_{b}—(CFR′f)_{c}SO₃M, wherein R_{f} and R′_{f} are independently selected from F, Cl or a perfluorinated alkyl group having 1 to 10 carbon atoms, a=0, 1 or 2, b=0-1, and c=0 to 6, and m is hydrogen, Li, Na, K or N(R₁)(R₂)(R₃)(R₄) and R₁, R₂, R₃, and R₄ are the same or different and are H, CH₃ or C₂H₅.

16. A process to manufacture a composite polymeric ion exchange membrane having opposing surfaces, said process comprising the steps of:
(a) providing a solution or a dispersion comprising at least one ion exchange polymer,
(b) providing a porous nonwoven web material comprising non-conductive unconsolidated polymer fibers, and
(c) contacting said solution or dispersion with said web such that, when dry, said at least one ion exchange polymer is impregnated between the opposing surfaces of said nonwoven web and such that said at least one ion exchange polymer has a volume fraction that is substantially equivalent throughout the composite membrane and which volume fraction between the opposing surfaces is greater than 50 percent.

17. The process according to claim 16 resulting in a composite polymeric ion exchange membrane having an ionic conductivity of greater than 80 mS/cm.

18. The composite polymeric ion exchange membrane of claim 3 wherein said anion exchange polymer is selected from the group consisting of:
(i) the at least partially fluorinated polyaromatic polymer backbone includes the repeating unit of Formula I:
wherein
A is a single bond, alkylene, fluoroalkylene, or an arylene that is optionally substituted with a halide, alkyl, fluoroalkyl and/or cation functional group; 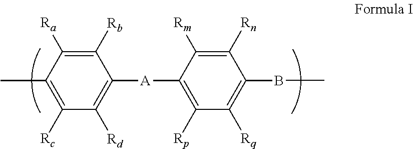
B is a single bond, oxygen or NR, wherein R is H, alkyl, fluoroalkyl or aryl, optionally substituted with halide, alkyl, a crosslinker and/or fluoroalkyl; and
Rₐ, Rb, Rₑ, Rd, Rm, Rn, Rp and R_{q} are each independently selected from the group consisting of hydrogen, fluorine, a crosslinking group and a cationic functional group; and
wherein at least one of A, B, Rₐ, Rb, R_{c}, Rd, Rᵢₘ R_{″}, Rₚ and R_{q} is fluorinated, and
(ii) the at least partially fluorinated polyaromatic polymer backbone includes the repeating unit of 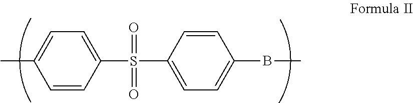
wherein B is a single bond, oxygen or NR, wherein R is H, alkyl, fluoroalkyl or aryl, optionally substituted with halide, alkyl, a crosslinker and/or fluoroalkyl.

19. The composite polymeric ion exchange membrane of claim 1 wherein the ion exchange polymer has a volume fraction of at least 60 percent.

20. The composite polymeric ion exchange membrane of claim 1 wherein there is no through-plane conductivity loss (z-axis) due to the presence of said web in the membrane.

21. The composite polymeric ion exchange membrane of claim 1 wherein the through-plane conductivity is at least 80% of that for the constituent unreinforced ion exchange polymer.
